(19) United States
(12) Patent Application Publication
(10) Pub. No.: US 2025/0282266 A1
(43) Pub. Date: Sep. 11, 2025

(54) SEATING ASSEMBLY, FOLDING MECHANISM, STORAGE DEVICE AND CHILD SAFETY SEAT

(71) Applicant: WONDERLAND SWITZERLAND AG, Steinhausen (CH)

(72) Inventor: Guanghui ZHAO, Dongguan, Guangdong (CN)

(73) Assignee: WONDERLAND SWITZERLAND AG, Steinhausen (CH)

(21) Appl. No.: 18/858,610

(22) PCT Filed: Sep. 22, 2023
(86) PCT No.: PCT/EP2023/076271

§ 371 Date: Oct. 21, 2024

(30) Foreign Application Priority Data
Sep. 23, 2022 (CN) 202211170356.0
Dec. 23, 2022 (CN) 202211668176.5
Jan. 4, 2023 (CN) 202310008869.X

(51) Int. Cl. B60N 2/28

(52) U.S. Cl. CPC B60N 2/2821; B60N 2/2851; B60N 2/2875

(57) ABSTRACT

The present disclosure provides a seating assembly for detachably connecting to a backrest of a child safety seat. The seating assembly includes a base; a seating body slidably connected to the base, the seating body being positioned at different positions with respect to the base; and a movable element located between the backrest and the seating body, wherein when the backrest is detached with respect to the seating body, the movable element is disengaged from the backrest and locked with the base to lock movement of the seating body with respect to the base. The present disclosure also provides a folding mechanism and a storage device. The present disclosure also a child safety seat including a seating assembly and/or a folding mechanism and/or a storage device.

This application is a National Stage application of PCT/EP2023/076271, entitled “SEATING ASSEMBLY, FOLDING MECHANISM, STORAGE DEVICE AND CHILD SAFETY SEAT” and filed on Sep. 22, 2023, which claims the benefit of Chinese Application No. 202211170356.0, filed on Sep. 23, 2022, Chinese Application No. 202211668176.5, filed on Dec. 23, 2022, and Chinese Application No. 202310008869.X, filed on Jan. 4, 2023, all of which are incorporated herein by reference in their entirety.”

### TECHNICAL FIELD

The present disclosure relates to a child safety seat, and specifically, relates to a seating assembly, a folding mechanism and a storage device of the child safety seat.

### BACKGROUND

With increasing attention to the children's travel safety, a child safety seat has become an indispensable riding tool for a child.

### SUMMARY

A first aspect of the present disclosure provides a child safety seat and a seating body thereof, so as to prevent uncomfortable seating feeling for children when the seat is in the usage mode without a backrest.

In one embodiment, the first aspect of the present disclosure provides a child safety seat. The child safety seat includes a seating assembly including a base and a seating body, the seating body being slidably connected to the base, the seating body being positioned at different positions with respect to the base; and a backrest detachably connecting to the seating body. The backrest includes a locking element, when the seating body does not slide to a preset position with respect to the base, the locking element is not capable of being unlocked, and when the seating body slides to the preset position with respect to the base, the locking element is capable of being unlocked.

In one embodiment, the seating assembly further includes a movable element located between the backrest and the seating body, wherein when the backrest is detached with respect to the seating body, the movable element is disengaged from the backrest and locked with the base to lock movement of the seating body with respect to the base.

In one embodiment, an engaging hole is formed in the base, and when the backrest is detached with respect to the seating body, the movable element is disengaged from the backrest and is engaged with the engaging hole.

In one embodiment, the backrest includes an abutting element, the movable element comprises a rotating rod rotatably connected to the seating body and an elastic element connected to the rotating rod, the rotating rod comprises a first end and a second end. When the backrest is not detached, the second end of the rotating rod is pressed by the backrest, so that the first end is opposite to the engaging hole and located outside the engaging hole, and the elastic element is configured to provide a force for moving the first end of the rotating rod toward the engaging hole.

In one embodiment, when the seating body slides to a preset position with respect to the base, the backrest is in a vertical state.

In one embodiment, a rear edge of the base is formed with an avoidance slot facing the backrest, and when the seating body slides to a preset position, the locking element is opposite to the avoidance slot, so as to allow the backrest to be detached.

In one embodiment, a rear edge of the base is formed with an avoidance slot facing the backrest, when the seating body slides to a preset position, the locking element is unlocked through the avoidance slot, and when the seating body does not slide to the preset position, the locking element is not capable of being unlocked through the avoidance slot.

In one embodiment, the locking element comprises an engaging hook and an operating element rotatably provided on the backrest, the seating assembly further comprises an engaging rod fixed on the seating body, the engaging hook is fixedly connected to the operating element, the engaging hook has a hook part facing the engaging rod and hooking the engaging rod, the engaging hook slides with respect to the base along with the seating body, and the hook part is opposite to the avoidance slot when the seating body slides to the preset position.

In one embodiment, the seating body comprises a seat body, the seat body is formed with an accommodating groove for receiving the locking element, and the locking element is fixed to a bottom end of the backrest.

In one embodiment, the seating assembly comprises an adjustment assembly between the base and the seating body, the base comprises a positioning guide rail, and the positioning guide rail is provided with a plurality of positioning holes spaced apart from each other, and the seating body is slidably provided on the base and cooperates with respective one of the positioning holes through the adjustment assembly.

In one embodiment, the seating body is provided with a guide slot for accommodating the positioning guide rail, a length of the guide slot is greater than a length of the positioning guide rail, the seating body comprises a first abutting part, and the first abutting part is placed on a side of the guide slot away from the backrest to abut against the positioning guide rail when the seating body slides to a preset position.

In one embodiment, the seating body comprises a seat body, and the seat body comprises an upper shell and a lower shell connected to each other. The adjustment assembly comprises a positioning element connected between the upper shell and the lower shell, an elastic element connected to the positioning element, and an adjusting element connected to the positioning element. The positioning element is selectively placed in one of the positioning holes, and the adjusting element is movably connected to the lower shell.

In one embodiment, the positioning element comprises a positioning rod, a connecting element connected to the positioning rod, and a linking element connected between the adjusting element and the connecting element. The lower shell is formed with a first guide groove, an extending direction of the first guide groove is parallel to an axial direction of the positioning hole, the connecting element is movably placed in the first guide groove, the connecting element is formed with a receiving groove, and the elastic element is placed in the receiving groove and abuts against the connecting element.

In one embodiment, the seating body further comprises armrests on both sides of the seat body, and a connecting hole corresponding to the first guide groove is formed on an inner side of the armrest, and the positioning element passes through the positioning hole and is placed in the connecting hole.

In one embodiment, the seating body includes an armrest, a top portion of the armrest is formed with a first curved sliding slot and a second curved sliding slot communicated with each other, the backrest comprises a leaning part and side leaning parts on both sides of the leaning part, a sliding part protrudes from a bottom portion of each of the side leaning parts, the sliding part is slidably placed in the first curved sliding slot, a cross-section of each of the first curved sliding slot and the second curved sliding slot is matched with a cross-section of the sliding part.

The first aspect of the present disclosure also provides a seating assembly for detachably connecting to a backrest. The seating assembly includes a base; a seating body slidably connected to the base, the seating body being positioned at different positions with respect to the base; and a movable element located between the backrest and the seating body, wherein when the backrest is detached with respect to the seating body, the movable element is disengaged from the backrest and locked with the base to lock movement of the seating body with respect to the base.

In one embodiment, an engaging hole is formed in the base, and when the backrest is detached with respect to the seating body, the movable element is disengaged from the backrest and is engaged with the engaging hole.

In one embodiment, an engaging hole is formed in the base, the movable element comprises a rotating rod rotatably connected to the seating body and an elastic element connected to the rotating rod, the rotating rod comprises a first end and a second end. When the backrest is not detached, the second end of the rotating rod is pressed by the backrest, so that the first end is opposite to the engaging hole and located outside the engaging hole, and the elastic element is configured to provide a force for moving the first end of the rotating rod toward the engaging hole.

In one embodiment, the seating assembly comprises an adjustment assembly between the base and the seating body, the base comprises a positioning guide rail, and the positioning guide rail is provided with a plurality of positioning holes spaced apart from each other, and the seating body is slidably provided on the base and cooperates with respective one of the positioning holes through the adjustment assembly.

In one embodiment, the backrest includes a locking element, the base is formed with an avoidance slot for cooperating with the locking element, the seating body comprises a seat body, the seat body is formed with an accommodating groove for receiving the locking element, and the avoidance slot at least partially overlaps with the accommodating groove.

In the child safety seat and the seating assembly, only when the seating body slides to the preset position, the backrest and the seating body may be unlocked therebetween, and the backrest may be detached from the seating body. In other words, the backrest may be detached from the seating body only when the seating body slides to the preset position with respect to the base. After the backrest is detached, the movable element is disconnected with the backrest and the base, the seating body will not be able to slide with respect to the base at this time. In this way, when the child safety seat is in the second mode with the backrest removed, the seating body will only be in the preset position, which can avoid misoperation by the user, thereby ensuring the comfort of the child in the second mode.

A second aspect of the present disclosure provides a child safety seat and a folding mechanism thereof. Specifically, the present disclosure provides a foldable child safety seat. More specifically, the present disclosure provides a folding mechanism of a child safety seat with simple structure, convenient operation and high safety level. Optionally, the present disclosure provides a child safety seat which may be folded through sliding connection between the seat part and the backrest.

In one embodiment of the second aspect provides a folding mechanism of a child safety seat for folding a backrest of the child safety seat with respect to the seat part. The folding mechanism includes a sliding groove disposed on one of the seat part and the backrest; a sliding rib disposed on the other of the seat part and the backrest; a locking structure operated to switch between a locking position and an unlocking position. The backrest is fixed with respect to the seat part and is in an unfolded state when the locking structure is in the locking position; and the backrest is foldable with respect to the seat part by means of sliding fit between the sliding groove and the sliding rib to be in a folded state when the locking structure is in the unlocking position.

In one embodiment, the sliding groove is disposed on each of both sides of the seat part, and the sliding rib is disposed on each of both sides of the backrest.

In an embodiment, the sliding groove is disposed on a top surface of an armrest at each of both sides of the seat part.

In one embodiment, the sliding rib is disposed on a bottom surface of each of two side wings of the backrest, and corresponds to the sliding groove.

In one embodiment, the armrest at each of both sides of the child safety seat part includes a front armrest and a rear armrest spaced apart from each other. In an unfolded state, the sliding rib is in a rear sliding groove of the rear armrest, and in a folded state, the sliding rib is in a front sliding groove of the front armrest.

In one embodiment, a virtual vertical plane is defined between the front armrest and the rear armrest. The virtual vertical plane is in a gap between the front armrest and the rear armrest in a front-rear direction and is perpendicular to a base. When the backrest of the child safety seat is locked with respect to the seat part, the backrest is located at a rear side of the virtual vertical plane; and when the backrest is unlocked with respect to the seat part, the backrest may move forward along the rear armrest and gradually pass through the virtual vertical plane, and then continue to move forward along the front armrest until the backrest is folded with respect to the seat. At this time, the entire backrest is located at a front side of the virtual vertical plane.

In one embodiment, the sliding rib and the sliding groove have complementary T-shaped structures, and a cross section of the sliding groove is in an inverted T shape.

In one embodiment, the locking structure is disposed on a lower side of the backrest. The folding mechanism further includes an engaging rod fixed to the child safety seat, and the locking structure is in the locking position by engagement with the engaging rod and is in the unlocking position by disengagement from the engaging rod.

In one embodiment, the locking structure includes an operating element at least partially exposed and disposed on the backrest; a locking hook assembly pivotally connected to a fixing rod of the backrest, and protrudes from a bottom side of the backrest, wherein the locking hook assembly is engaged with the engaging rod when the locking structure is in the locking position; and a connecting rod connected between the locking hook assembly and the operating element, wherein the connecting rod is fixedly connected with the locking hook assembly and movably connected with the operating element, wherein the locking hook assembly is capable of being disengaged from the engaging rod by operating the operating element.

In one embodiment, the locking hook assembly includes a first locking hook and a second locking hook. One end of each of the first locking hook and the second locking hook is connected with the operating element through a corresponding connecting rod of two connecting rods; the other ends of the first locking hook and the second locking hook are in hook shapes and opposite to each other; and middle parts of the first locking hook and the second locking hook are pivotally connected to the fixing rod of the backrest, respectively.

In one embodiment, one of the two connecting rods is located at an upper portion of the operating element, and the other of the two connecting rods is located at a lower portion of the operating element, the connecting rod at the lower portion is pivotally connected with the operating element, and the connecting rod at the upper portion is pivotably and slidably connected with the operating element.

In one embodiment, the locking structure includes two locking hook assemblies, and the two locking hook assemblies are disposed symmetrically with respect to the central axis of the backrest.

In an embodiment, the folding mechanism further comprises an elastic restoring element, one end of the elastic restoring element is fixed to a frame of the backrest, and the other end of the elastic restoring element is fixed to the locking structure, so as to apply a force to make the locking structure in the locking position.

In one embodiment, the other end of the elastic restoring element is fixed to the operating element, or the locking hook assembly, or the connecting rod.

In one embodiment, the backrest is removable from the seat part as being in a folded state.

The present disclosure also provides a child safety seat. The child safety seat includes a seat part; a backrest; and the folding mechanism according to any of the above embodiments, so that the backrest may be folded with respect to the seat part, and then fold the child safety seat.

In one embodiment, the child safety seat further includes a storage device detachably installed to the sliding groove of the seat part.

A third aspect of the present disclosure provides a storage device. The storage device is detachably installed on a seat part of a child safety seat. The storage device comprises: a connecting part slidably connected to the child safety seat in a front-rear direction; and an accommodating structure fixed on the connecting part for accommodating objects.

In one embodiment, the connecting part is slidable in the front-rear direction along a connecting structure of the child safety seat and is positioned at at least one position on the connecting structure.

In one embodiment, the connecting part comprises a first sliding part extending from one end of the connecting part and being on a lower side of the connecting part, to slidingly cooperate with a corresponding second sliding part provided on the connecting structure.

In one embodiment, the first sliding part is a sliding rib with an inverted T-shaped structure, and the second sliding part is a sliding groove that is complementary with the sliding rib in shape.

In one embodiment, the storage device further comprises a positioning element provided on the connecting part of the storage device. The storage device is positioned at different positions on the connection structure through the positioning element.

In one embodiment, the storage device further comprises a positioning element provided on the connecting part of the storage device. The positioning element is pivotably connected to the connecting part and has an engaged position in which the connecting structure is engaged and a disengaged position from which the connecting structure is disengaged.

In one embodiment, one end of the positioning element is pivotably connected to the connecting part, and the positioning element comprises a positioning protrusion on a lower side of the other end of the positioning element, for engaging with the child safety seat, so that the connecting part is positioned on the child safety seat.

In one embodiment, the positioning element further comprises an elastic arm having an arm-like structure extending from one end of the positioning element toward the other end of the positioning element, wherein a tail end of the elastic arm abuts against the connecting part to constantly provide a force to bias the positioning protrusion toward the child safety seat.

In one embodiment, the positioning element further comprises an operating part, and the operating part is pulled to overcome elastic rotation of the elastic arm, so that the positioning protrusion is disengaged with the child safety seat.

In one embodiment, the positioning element further comprises an operating part, and the operating part is operated to move the positioning element between the engaged position and the disengaged position.

The third aspect of the present disclosure provides a child safety seat. The child safety seat includes the storage device according to any one of the previous embodiments and a seat part. The storage device is placed on the seat part.

In one embodiment, a second sliding part of the child safety seat is provided on a top surface of an armrest on at least one side of the seat part.

In one embodiment, the second sliding part of the child safety seat is further provided with at least one positioning hole to engage with the positioning protrusion.

In one embodiment, the child safety seat further comprises a base, side covers and a bottom cover, wherein the side covers are fixedly connected to both sides of the child safety seat, and the bottom cover is fixedly connected between the base and the seat part.

In one embodiment, the child safety seat further comprises a backrest slidably connected to the seat part along the second sliding part of the seat to fold and unfold the backrest with respect to the seat part.

### BRIEF DESCRIPTION OF THE DRAWINGS

The accompanying drawings are included to provide a further understanding of the present disclosure and are incorporated in and constitute a part of this specification, which illustrate embodiments of the present disclosure and together with the description below serve to explain the concept of the present disclosure.

FIG. 1 schematically shows a perspective view of a child safety seat according to an embodiment of a first aspect of the present disclosure.

FIG. 2 schematically shows an internal schematic view of a seating body in FIG. 1.

FIG. 3 schematically shows a perspective view of a backrest in FIG. 1.

FIG. 4 schematically shows an enlarged view of a part A in FIG. 2.

FIG. 5 schematically shows a top view of the child safety seat in FIG. 1 in a preset position.

FIG. 6 schematically shows a cross-sectional view of the child safety seat taken along a line C-C in FIG. 5.

FIG. 7 schematically shows a cross-sectional view of the child safety seat in FIG. 5 when it is in a non-preset position.

FIG. 8 schematically shows an enlarged view of a part B in FIG. 2.

FIG. 9 schematically shows a cross-sectional view of a child safety seat according to another embodiment of the first aspect of the present disclosure.

FIG. 10 schematically shows a perspective view of a seating assembly in FIG. 1.

FIG. 11 schematically shows a cross-sectional view of the child safety seat taken along a line D-D in FIG. 10.

FIG. 12 schematically shows a perspective view of a child safety seat according to another embodiment of the first aspect of the present disclosure.

FIG. 13 schematically shows the child safety seat in FIG. 12 with the backrest removed.

FIG. 14 shows a perspective view of a child safety seat according to an embodiment of a second aspect of the present disclosure.

FIG. 15 shows a perspective view of a child safety seat in an unfolded state according to an embodiment of the second aspect of the present disclosure.

FIG. 16 shows a perspective view of the child safety seat of FIG. 15 when the locking structure is in an unlocking position and the backrest begins to be folded with respect to the seat part.

FIG. 17 shows a perspective view of the child safety seat of FIG. 16 that is further folded.

FIG. 18 shows a perspective view of the child safety seat of FIG. 16 in a fully unfolded state.

FIG. 19 shows a perspective view of the seat part of the child safety seat according to an embodiment of the second aspect of the present disclosure.

FIG. 20 shows a perspective view of the backrest of the child safety seat according to an embodiment of the second aspect of the present disclosure.

FIGS. 21a to 21e show views of the child safety seat when the locking structure is in a locking position according to an embodiment of the second aspect of the present disclosure, wherein FIG. 21a shows a front view of the child safety seat when the locking structure is in the locking position, FIG. 21b shows a sectional view taken along line E-E in FIG. 21a, FIG. 21c shows a partial enlarged view at a block F shown in FIG. 21b, FIG. 21d shows a perspective view of the child safety seat when the locking structure is in the locking position, and FIG. 21e shows a partial enlarged view of the locking structure shown in FIG. 21d.

FIGS. 22a to 22e show views of the child safety seat when the locking structure is in the unlocking position according to an embodiment of the second aspect of the present disclosure, wherein FIG. 22a shows a front view of the child safety seat when the locking structure is in the unlocking position, FIG. 22b shows a sectional view taken along line G-G shown in FIG. 22a, FIG. 22c shows a partial enlarged view at a block H in FIG. 22b, FIG. 22d shows a perspective view of the child safety seat when the locking structure is in the unlocking position, and FIG. 22e shows the child safety seat at the locking structure in FIG. 22d.

FIG. 23 shows a perspective view of the child safety seat with a storage device installed on the seat part.

FIG. 24 schematically shows a perspective view of a seat according to an embodiment of a third aspect of the present disclosure.

FIG. 25 schematically shows a side view of a seat according to an embodiment of the third aspect of the present disclosure.

FIG. 26 schematically shows a perspective view of a storage device according to an embodiment of the third aspect of the present disclosure.

FIG. 27 schematically shows a perspective view of a seat part according to an embodiment of the third aspect of the present disclosure, in which a storage device is placed on a side of the seat part.

FIG. 28 schematically shows a perspective view of the seat part according to an embodiment of the third aspect of the present disclosure, in which the storage device on one side of the seat part is in an installed state, and the storage device on the other side of the seat part is being installed.

FIG. 29 schematically shows a perspective view of the seat part according to an embodiment of the third aspect of the present disclosure, in which the storage device is provided on each of both sides of the seat part.

FIG. 30 shows a top view of the seat part of FIG. 29.

FIG. 31 shows a cross-sectional view of the seat part taken along a line J-J in

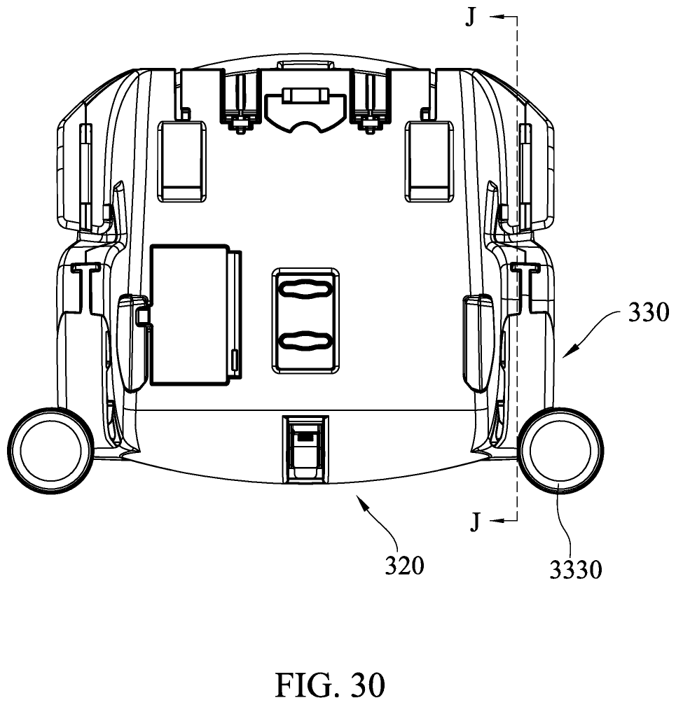

FIG. 30.

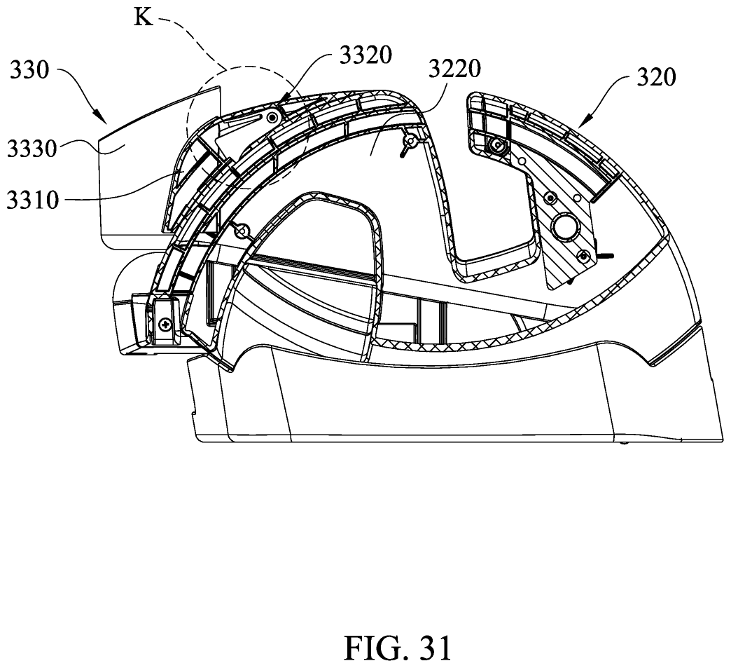

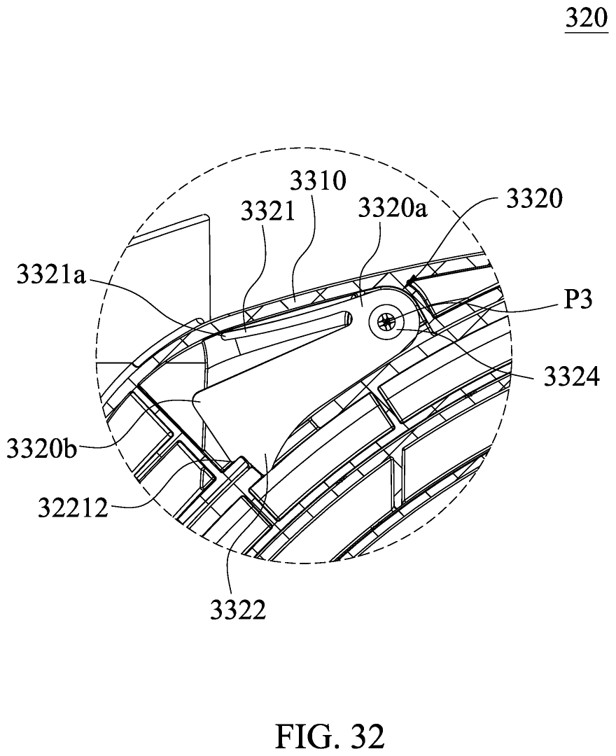

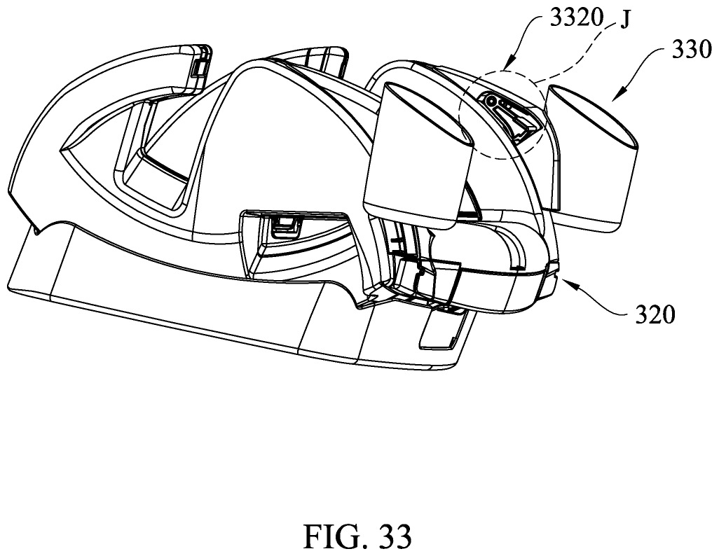

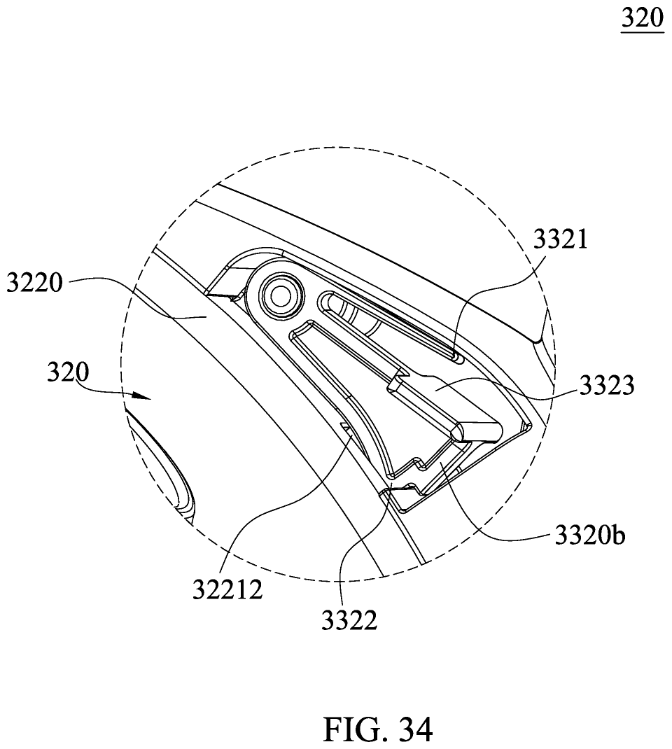

FIG. 32 shows an enlarged view of a part K shown in FIG. 31.

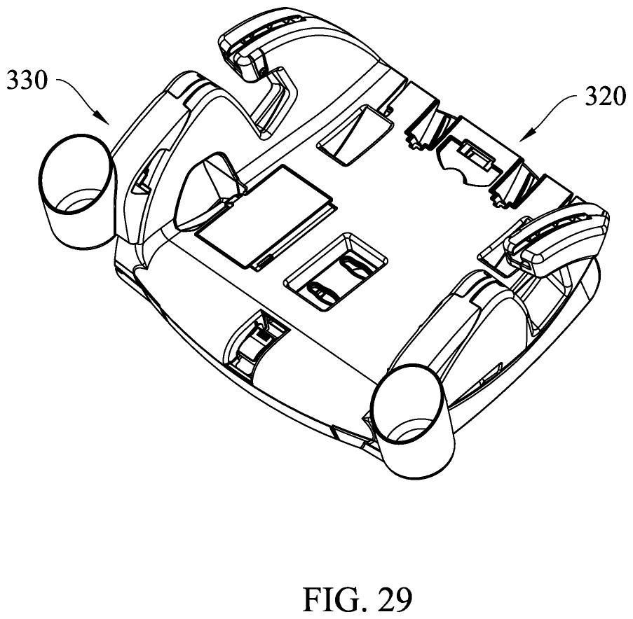

FIG. 33 shows a perspective view of the seat part of FIG. 29 from another angle.

FIG. 34 shows an enlarged view of a part Q shown in FIG. 33.

List of reference numerals:

| | |
|---|---|
| seat | 110 |
| seating assembly | 120 |
| base | 121 |
| curved top surface | 1211 |
| positioning guide rail | 1212 |
| positioning hole | 12121 |
| engaging hole | 12122 |
| avoidance slot | 1214 |
| seating body | 122 |
| guide slot | 1220 |
| seat body | 1221 |
| upper shell | 12211 |
| lower shell | 12212 |
| installation port | 1221h |
| first abutting part | 12213 |
| first guide groove | 12214 |
| second guide groove | 12215 |
| accommodating groove | 12216 |
| armrest | 1222 |
| first curved sliding slot | 12221 |
| second curved sliding slot | 12222 |
| opening | 12223 |
| adjustment assembly | 123 |
| positioning element | 1231 |
| positioning rod | 12311 |
| connecting element | 12312 |
| linking element | 12313 |
| receiving groove | 12314 |
| first elastic element | 1232 |
| adjusting element | 1233 |
| movable element | 124 |
| rotating rod | 1241 |
| first end | 12411 |
| second end | 12412 |
| second elastic element | 1242 |
| rotating shaft | 1243 |
| object placement element | 125 |
| engaging rod | 129 |
| backrest | 130 |
| leaning part | 131 |
| side leaning part | 132 |
| sliding part | 1321 |
| abutting element | 136 |
| opening slot | 1361 |
| locking element | 140, 140′ |
| operating element | 141 |
| operating opening | 1411 |
| first fixing shaft | 142 |
| engaging hook | 143 |
| hook part | 1431 |
| second fixing shaft | 145 |
| elastic restoring element | 147 |
| child safety seat | 21 |
| seat part | 210 |
| base | 2110 |
| armrest | 2120 |
| front armrest | 2120a |
| rear armrest | 2120b |
| sliding groove | 2130 |
| front sliding groove | 2130a |
| rear sliding groove | 2130b |
| engaging rod | 2140 |
| locking hole | 2150 |
| storage device | 2160 |
| backrest | 220 |
| locking structure | 2210 |
| locking hook assembly | 2211 |
| first locking hook | 2211a |
| second locking hook | 2211b |
| connecting rod | 2212 |
| first connecting rod | 2212a |
| second connecting rod | 2212b |
| fixing rod | 2213 |
| elastic restoring element | 2214 |
| operating element | 2215 |
| connecting groove | 2215a |
| sliding rib | 2230 |
| cover plate | 2240 |
| headrest | 230 |
| virtual vertical plane | P2 |
| central axis | M2 |
| seat | 31 |
| backrest | 310 |
| seat part | 320 |
| housing | 3210 |
| side cover | 3211 |
| bottom cover | 3212 |
| armrest | 3220 |
| connecting structure | 3221 |
| second sliding part | 32211 |
| positioning hole | 32212 |
| abutting surface | 32201 |
| seat part body | 3230 |
| storage device | 330 |
| connecting part | 3310 |
| first sliding part | 3311 |
| positioning element | 3320 |
| first end | 3320a |
| second end | 3320b |
| elastic arm | 3321 |
| positioning protrusion | 3322 |
| operating part | 3323 |
| pin | 3324 |
| pivot point | P3 |
| accommodating structure | 3330 |
| base | 340 |

### DETAILED DESCRIPTION

The child safety seat configured to be installed in a vehicle can improve the safety of children while riding in the vehicle. To accommodate the children of different ages, the child safety seat typically offers two usage modes, that is, one usage mode with a backrest and the other usage mode without a backrest. In the usage mode with the backrest, a backrest angle may be adjusted to suit younger children. In the usage mode without the backrest, that is, after the backrest is removed from a seat part of the child safety seat, it may be used for older children. In the usage mode without the backrest, it is necessary to position the seat part at a specific position on a base. For example, a seating plane of the seat part is configured to be substantially parallel to a traveling direction of the vehicle, ensuring comfortable seating for the children. However, when the backrest of the existing child safety seat is removed, the seat part may be randomly adjusted with respect to the base, so that the seating plane may have different inclination angles. As such, it is difficult to ensure the comfortable seating for the children in the usage mode without the backrest.

Generally, the child safety seat is fixed on a back seat of the vehicle, occupying a large amount of space of the back seat of the vehicle. Most of the child safety seats currently on the market have a large size and are non-foldable. Placing the child safety seat in the back seat results in little left in the back seat of the vehicle or a limited space left for another passenger to sit or put some items thereon, to cause inconvenient for travelling. Moreover, when the child safety seat is not temporarily used, it is necessary to remove the entire child safety seat from the back seat of the vehicle to make room for passenger to sit or put items thereon; and when the child safety seat is used again, it is required to move the entire child safety seat back to the back seat of the vehicle and fix it thereon. It is not only cumbersome and inconvenient for operation, but also can increase transportation cost of the child safety seat. Furthermore, repeated loading and unloading can increase possibility of incorrect installation or unstable placement of the child safety seat, and a large space will be occupied to store the child safety seat that has been detached due to its large size, which can bring inconvenience to a user.

Furthermore, for sake of convenience, the children often place objects such as cups and toys on the child safety seat. The child safety seats are generally provided with storage cups that are usually detachable structures. However, traditional storage cups are usually detachably connected to the child safety seat in a vertical direction (i.e., an up-down direction). This means that if a child's foot accidentally kicks the storage cup from below, the storage cup may be skewed or accidentally detached, and potentially causing spills and safety hazards. In addition, the position of the storage cup in the existing child safety seat cannot be adjusted, which brings inconvenience to children of different sizes.

Hereinafter, exemplary embodiments of the present disclosure will be described in detail with reference to the accompanying drawings. While the present disclosure is susceptible to various modifications and alternative forms, specific embodiments thereof are shown by way of example in the accompanying drawings. However, the present disclosure should not be construed as limited to the embodiments set forth herein, but on the contrary, it will cover all modifications, equivalents and alternatives falling within the spirit and scope of the present disclosure.

The present disclosure will be described in detail with reference to the accompanying drawings.

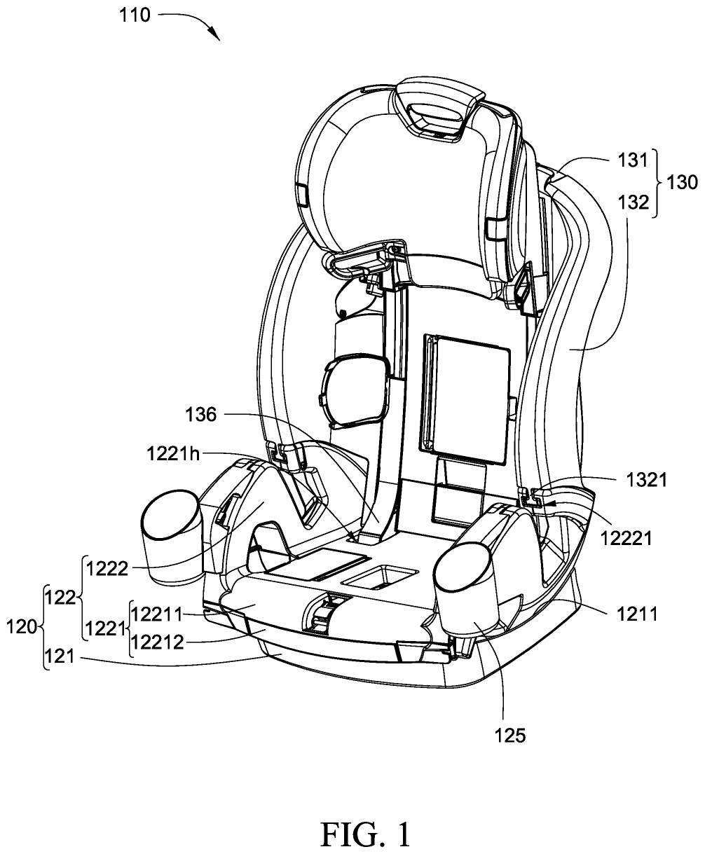

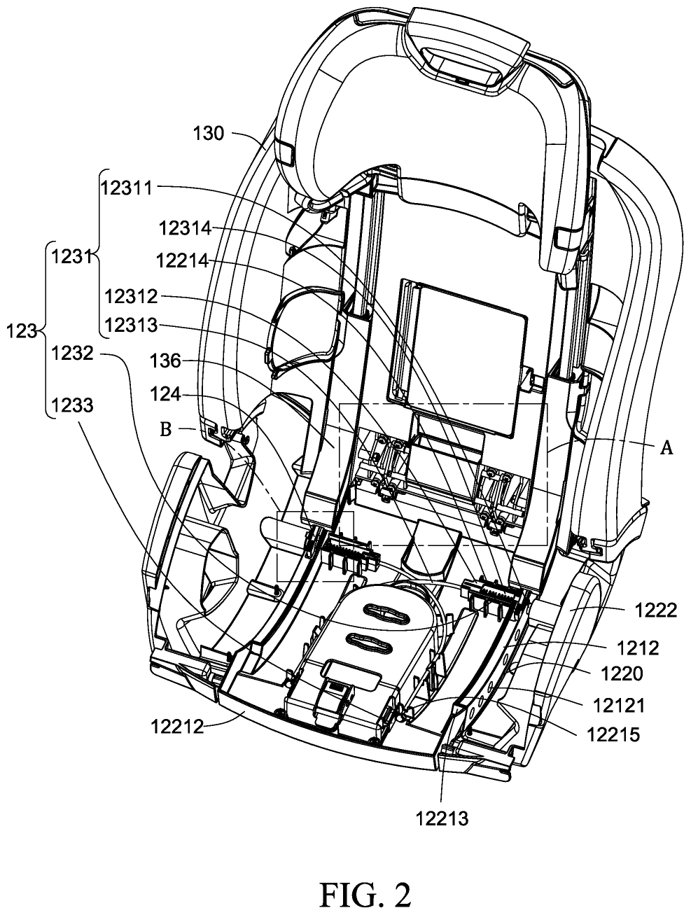

Referring to FIGS. 1 and 2, an embodiment of a first aspect of the present disclosure provides a child safety seat 110. The child safety seat includes a seating assembly 120 and a backrest 130 detachably provided on the seating assembly 120. The child safety seat 110 has a first mode in which the backrest 130 is provided and a second mode in which the backrest 130 is removed.

The seating assembly 120 includes a base 121, a seating body 122, and an adjustment assembly 123 between the base 121 and the seating body 122. The seating body 122 is slidably connected to the base 121 and may move with respect to the base 121 so as to be positioned in different positions. Specifically, when a user operates the adjustment assembly 123, a position of the seating body 122 with respect to the base 121 may be adjusted, thereby changing an inclination angle of a seating plane of the seating assembly 120 with respect to a horizontal reference plane.

Referring to FIGS. 1 and 2, in one embodiment, the base 121 includes a curved top surface 1211 and two positioning guide rails 1212. Each of the positioning guide rails 1212 is provided with a plurality of positioning holes 12121 spaced apart from each other. The seating body 122 is provided with two guide slots 1220 for accommodating the two positioning guide rails 1212. A length of the guide slot 1220 is greater than a length of the positioning guide rail 1212. The seating body 122 is slidably provided on the base 121 and may move forward and backward along the positioning guide rail 1212.

As shown in FIG. 1, the seating body 122 includes a seat body 1221 (which may be also referred to as “seat part”) and armrests 1222 on both sides of the seat body 1221. The seat body 1221 includes an upper shell 12211 and a lower shell 12212 connected to each other. Referring to FIG. 2, the guide slot 1220 is formed on the lower shell 12212. The positioning guide rail 1212 of the base 121 is provided throughout the lower shell 12212 via the corresponding guide slot 1220. In addition, the lower shell 12212 is also provided with a first abutting part 12213. The first abutting part 12213 is provided at a side of the guide slot 1220 away from the backrest 130. When the seating body 122 slides backward with respect to the base 121 to a preset position, the first abutting part 12213 is configured to abut against the positioning guide rail 1212, thereby restricting further backward sliding of the seating body 122.

That is, when the user cannot continue to slide the seating body 122 backward, the seating body 122 is in the preset position, that is, the backrest 130 is in a position where it may be detached from the seating body 122. Similarly, the lower shell 12212 is also provided with a second abutting part (not shown). The second abutting part is provided at a side of the guide slot 1220 close to the backrest 130 and is configured to restrict further forward sliding of the seating body 122 when the seating body 122 slides forward to abut against the positioning guide rail 1212. It can be understood that one or both of the first abutting part 12213 and the second abutting part may also be provided on the upper shell 12211.

As shown in FIG. 2, the adjustment assembly 123 is configured to be positioned with respect to different positioning holes 12121 to position the seating body 122 when the seating body 122 slides to different positions. In one embodiment, the adjustment assembly 123 includes a positioning element 1231 connected between the upper shell 12211 and the lower shell 12212, a first elastic element 1232 connected to the positioning element 1231, and an adjusting element 1233 connected to the positioning element 1231. The positioning element 1231 is selectively placed in one of the positioning holes 12121. The adjusting element 1233 is movably connected to the lower shell 12212 and may drive the positioning element 1231 to be disengaged from the positioning hole 12121 under the action of an external force. In one embodiment, a part of the adjusting element 1233 passes through a bottom portion of the lower shell 12212, so that the user may operate the adjusting element 1233 to disengage the positioning element 1231 from the positioning hole 12121. When the positioning element 1231 is disengaged from the positioning hole 12121, the user may push the backrest 130, so that the backrest 130 and the seating body 122 slide with respect to the base 121 to adjust the position of the seating body 122 on the base 121. When the positioning rod 12311 moves to the other positioning hole 12121 and releases the external force exerted on the adjustment element 1233, the positioning element 1231 may be positioned in the other positioning hole 12121 again through an elastic restoring force of the first elastic element 1232. In this way, the seating body 122 and the backrest 130 are fixed to the base 121 again.

In one embodiment, the positioning element 1231 includes a positioning rod 12311, a connecting element 12312 connected to the positioning rod 12311, and a linking element 12313 connected between the adjusting element 1233 and the connecting element 12312. In addition, two first guide grooves 12214 are provided on the lower shell 12212, and an extending direction of each of the first guide grooves 12214 is parallel to an axial direction of the positioning hole 12121. Each of the connecting elements 12312 is movably placed in the corresponding first guide groove 12214 to move toward or away from the positioning hole 12121 along the first guide groove 12214, so that the positioning rod 12311 extends into or out of the positioning hole 12121.

A connecting hole (not shown) corresponding to the first guide groove 12214 is formed on an inner side of the armrest 1222. The positioning rod 12311 passes through the positioning hole 12121 and is placed in the connecting hole, so that the seating body 122 and the base 121 are more stably connected with each other. The connecting element 12312 is formed with a receiving groove 12314, and the first elastic element 1232 is placed in the receiving groove 12314 and abuts against the connecting element 12312, so that after the positioning rod 12311 is disengaged from the positioning hole 12121, and in a process that the seating body 122 is sliding with respect to the base 121, the positioning rod 12311 extends into the other positioning hole 12121 through an elastic force. Two sets of second guide grooves 12215 are also formed on the lower shell 12212. The two linking elements 12313 of the two positioning elements 1231 are arranged to cross with each other, and each of the linking elements 2213 is movably placed in one set of second guide grooves 12215. The two linking elements 12313 are connected to the adjusting element 1233. The user can move the adjusting element 1233 away from the backrest 130 to drive the movement of the two linking elements 12313, thereby driving the two positioning rods 12311 to be disengaged from their respective positioning holes 12121. After the user releases the adjusting element 1233, the backrest 130 and the seating body 122 slide under the pushing of the user until the positioning rod 12311 faces one of the positioning holes 12121, and the positioning rod 12311 is inserted into the positioning hole 12121 under the action of the first elastic element 1232 to fix the seating body 122 to the base 121 again.

The backrest 130 is detachably connected to the seating body 122. When the backrest 130 is connected to the seating body 122, the backrest 130 may slide with respect to the base 121 along with the seating body 122, and the child safety seat 110 may be used by younger children in the first mode in which the backrest 130 is provided.

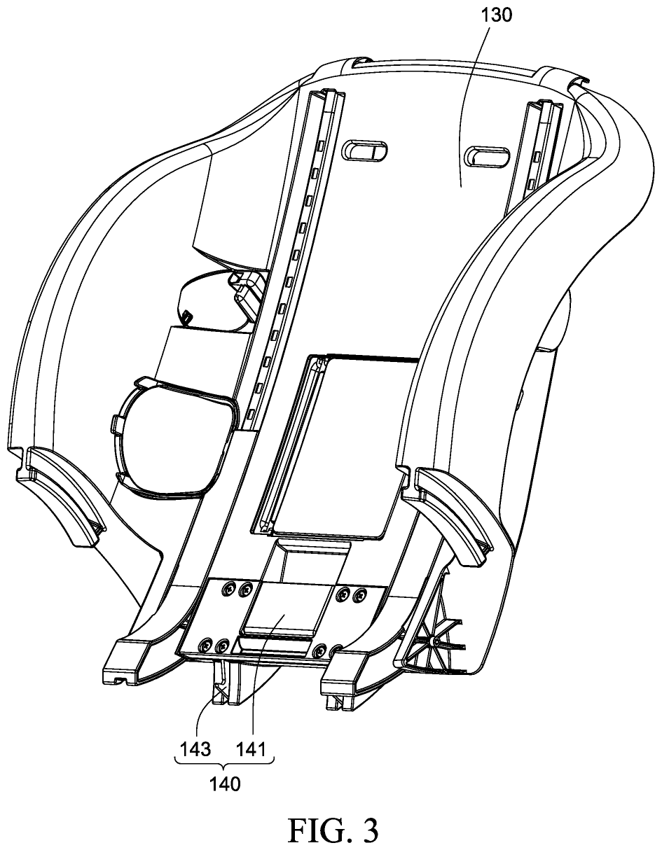

Referring to FIG. 3, the backrest 130 includes a locking element 140. When the locking element 140 is unlocked, the backrest 130 may be detached from the seating body 122. However, in this embodiment, the locking element 140 may be unlocked only when the seating body 122 is moved to the preset position with respect to the base 121. That is, when the seating body 122 does not slide to the preset position with respect to the base 121, the locking element 140 cannot be unlocked, and the backrest 130 cannot be detached from the seating body 122. In this way, the backrest 130 can be prevented from being detached by the user when the seating body 122 is not adjusted to an appropriate position, thereby affecting the comfort of the children sitting thereon.

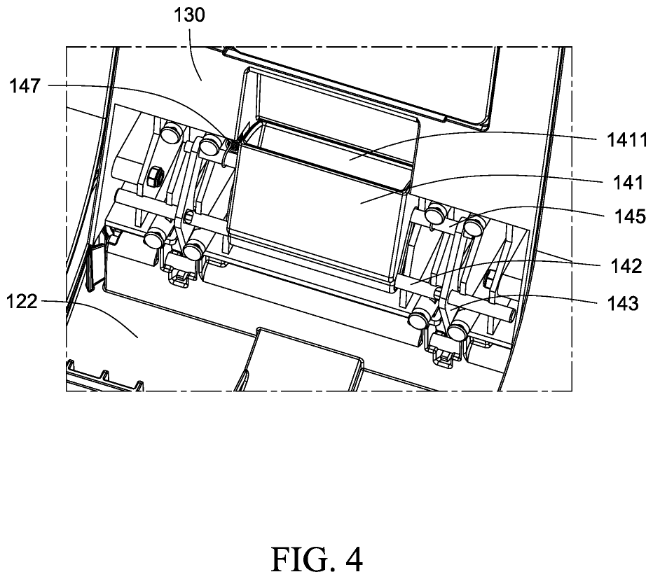

Referring to FIG. 3, in one embodiment, the locking element 140 includes an engaging hook 143 and an operating element 141 rotatably provided on the backrest 130. Specifically, referring to FIGS. 2 and 4, the locking element 140 further includes a first fixing shaft 142 and a second fixing shaft 145 that are fixed on the backrest 130. The operating element 141 and the engaging hook 143 are rotatably connected to the first fixing shaft 142, and one end of the engaging hook 143 is connected to the operating element 141 through the second fixing shaft 145. In this embodiment, an operating opening 1411 is provided at an upper end of the operating element 141 for the user to operate so as to rotate the operating element 141.

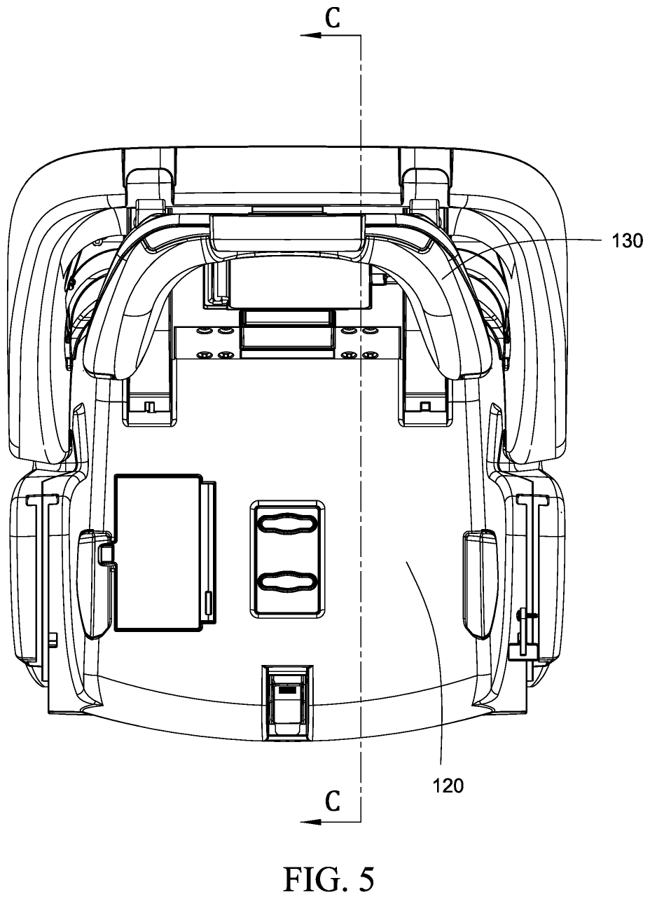

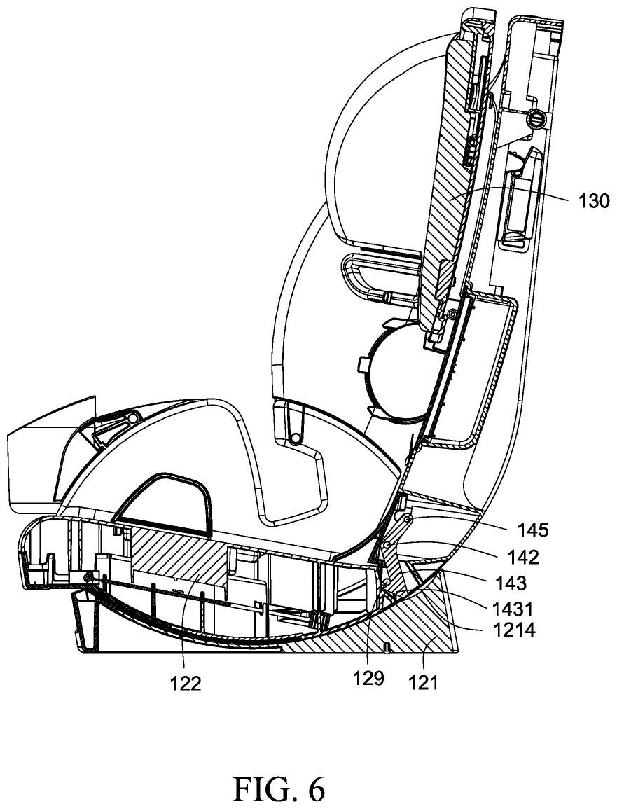

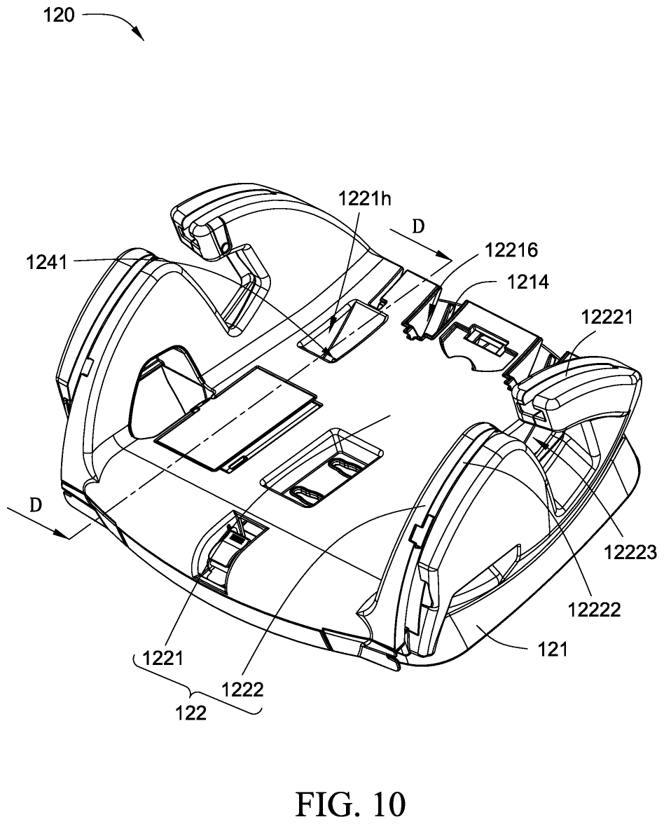

When the seating body 122 does not slide to the preset position with respect to the base 121, the locking element 140 locks the backrest 130 and the seating body 122 to prevent the backrest 130 from moving with respect to the seating body 122. Referring to FIGS. 5 and 6, when the seating body 122 slides with respect to the base 121 to the preset position shown in FIG. 6, the backrest 130 and the seating body 122 may be unlocked by the locking element 140, the backrest 130 may move with respect to the seating body 122, so that the backrest 130 may be detached from the seating body 122. At this time, the child safety seat 110 is in a second mode in which the backrest 130 is removed (see FIG. 10), used for older children. As shown in FIG. 6, when the seating body 122 slides to the preset position with respect to the base 121, a center position of the seating body 122 is in a center position of the base 121, and the backrest 130 is in a vertical state. With this arrangement, after the backrest 130 is removed, the child can sit comfortably in the seating body 122.

Referring to FIG. 6, the seating assembly 120 further includes an engaging rod 129 connected to the seating body 122. Referring to FIGS. 4 and 6, one end of the engaging hook 143 is linked with the operating element 141 through the second fixing shaft 145, and the other end of the engaging hook 143 has a hook part 1431 facing the engaging rod 129 and hooking the engaging rod 129.

In addition, in this embodiment, the base 121 is formed with an avoidance slot 1214 for matching with the locking element 140. In detail, the avoidance slot 1214 is formed on a rear edge of the base 121. When the seating body 122 slides to the preset position, the hook part 1431 of the engaging hook 143 corresponds to a position of the avoidance slot 1214. In one embodiment, an orthographic projection of the hook part 1431 of the engaging hook 143 falls within the avoidance slot 1214. When it is necessary to detach the backrest 130 from the seating body 122, the operating element 141 may be rotated, and the hook part 1431 of the engaging hook 143 may be driven to rotate counterclockwise about the first fixing shaft 142, so that the hook part 1431 is disengaged from the engaging rod 129. By providing the avoidance slot 1214 on the base 121, it can prevent the hook part 1431 from being interfered with and thus unable to be disengaged from the engaging rod 129 during rotation.

Referring to FIG. 4 again, in one embodiment, the locking element 140 further includes an elastic restoring element 147 connected to the second fixing shaft 145 with the operating element 141 for restoring the operating element 141 when the user releases the operating element 141. Furthermore, one end of the elastic restoring element 147 is connected to the second fixing shaft 145, and the other end of the elastic restoring element 147 is connected to the backrest 130. When the external force applied to the operating element 141 is removed, an elastic force of the elastic restoring element 147 may restore the operating element 141 and drive the engaging hook 143 to be restored.

In another embodiment, the operating element 141 is connected to the backrest 130 in a transition fit. In this way, even if the user releases the operating element 141 after the hook part 1431 is disengaged from the engaging rod 129, it will not automatically hook the engaging rod 129 again. In this way, when the hook part 1431 and the engaging rod 129 are just unlocked, and the backrest 130 and the seating body 122 are not separated, the backrest 130 and the seating body 122 may continue to maintain an unlocked state. On the other hand, when the backrest 130 is installed and it is necessary to lock the backrest 130 and the seating body 122, the operating element 141 may be operated to rotate in an opposite direction, so that the hook part hooks the engaging rod 129.

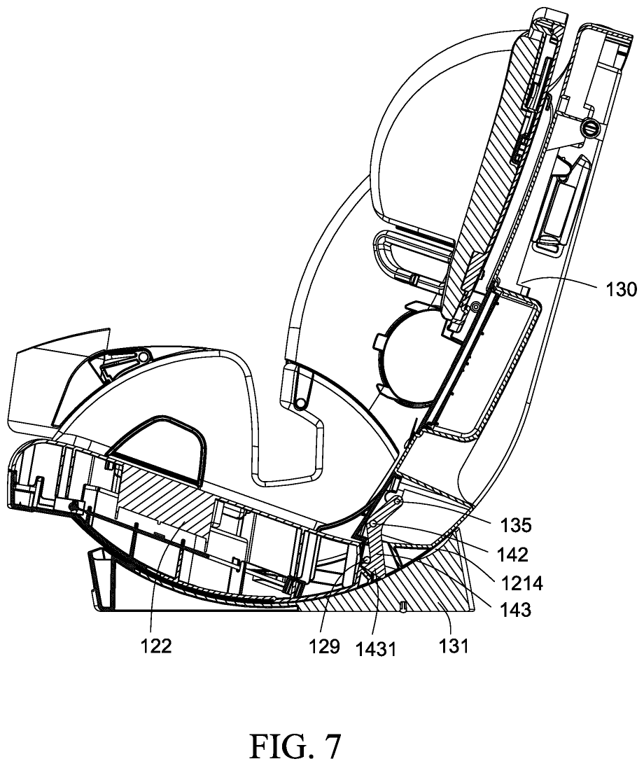

When the backrest 130 is not detached, the engaging hook 143 may slide with respect to the base 121 along with the seating body 122. Therefore, the hook part 1431 may be movable along with the seat body 1221 with respect to the base 121. Referring to FIG. 7, when the seating body 122 is moved to the non-preset position with respect to the base 121, the hook part 1431 of the engaging hook 143 will be misaligned with the avoidance slot 1214 and separated from each other. That is, an orthographic projection of the engaging hook 143 on the base 121 is located outside the avoidance groove 1214.

In this case, the rotation of the engaging hook 143 may be interfered by the base 121, and the user cannot rotate the operating element 141, nor can the hook part 1431 be disengaged from the engaging rod 129. Accordingly, when the seating body 122 is moved to the non-preset position with respect to the base 121, the user cannot unlock the locking between the backrest 130 and the seating body 122 by rotating the operating element 141, nor can the user detach the backrest 130 from the seating body 122. In this way, it is possible to prevent the user from detaching the backrest 130 when the seating plane of the seating body 122 is still tilted with respect to the reference horizontal plane, thereby affecting the comfort of the occupant. In addition, in this embodiment, after the backrest 130 is detached from the seating body 122, the movement of the seating body 122 will be locked, and the position of the seating body 122 can no longer be adjusted with respect to the base 121.

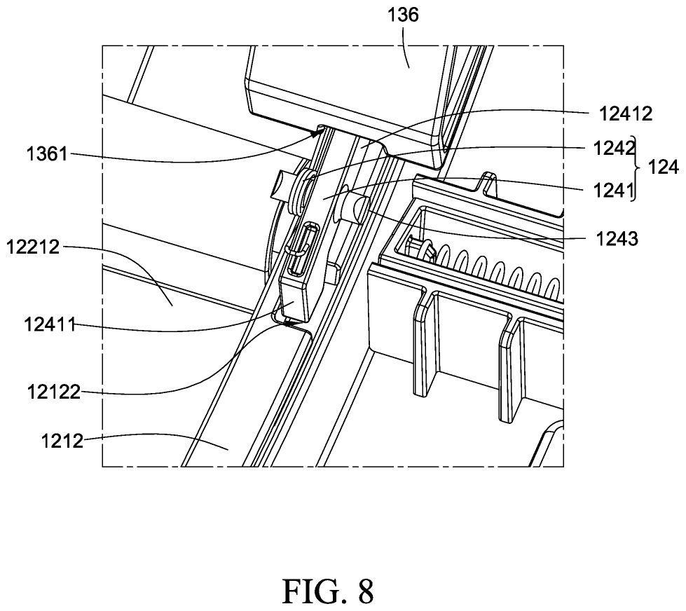

Referring to FIGS. 2 and 8, the seating assembly 120 further includes a movable element 124 connected between the backrest 130 and the seating body 122. In one embodiment, engaging holes 12122 are formed on the positioning guide rail 1212 of the base 121, and one end of the movable element 124 is disposed corresponding to the position of the engaging hole 12122. In this embodiment, the engaging holes 12122 are opened facing the upper shell 12211, but the present disclosure does not limit the position, number and direction of the engaging holes 12122. In addition, the backrest 130 of this embodiment further includes an abutting element 136 located on the inner side, and an opening slot 1361 is formed at an end of the abutting element 136.

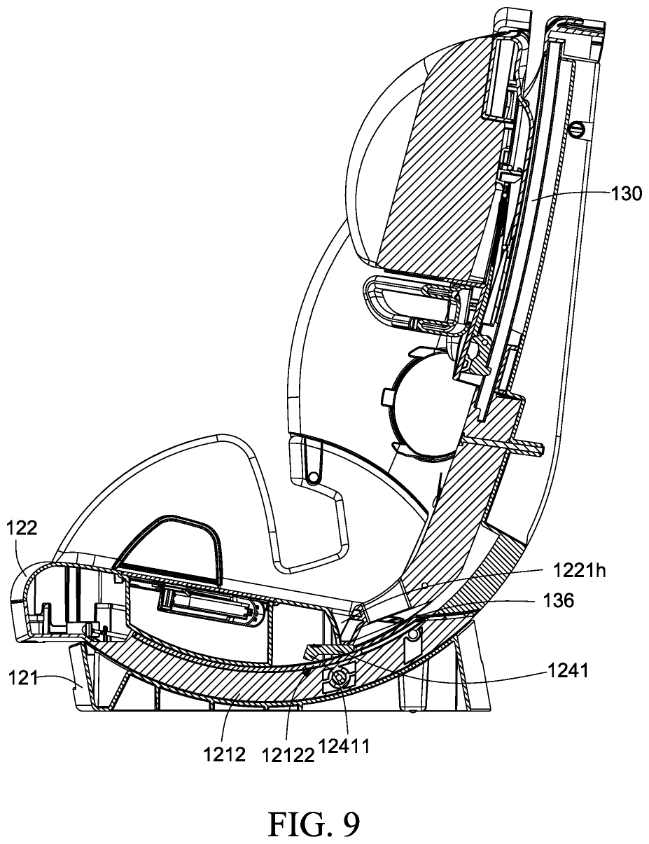

In detail, the movable element 124 includes a rotating rod 1241 that is rotationally connected to the seating body 122 and a second elastic element 1242. The rotating rod 1241 includes a first end 12411 and a second end 12412. Referring to FIGS. 8 and 9, the first end 12411 is opposite to the engaging hole 12122, and the second end 12412 is placed in the opening slot 1361 and abuts against the abutting element 136. Accordingly, when the backrest 130 is not detached, the second end 12412 of the rotating rod 1241 is pressed by the abutting element 136, so that the first end 12411 is kept outside the engaging hole 12122. It can be understood that the abutting element 136 may not be provided with the opening slot 1361, and the second end 12412 directly abuts against a lower surface of the abutting element 136. In this way, when the seating body 122 together with the backrest 130 moves with respect to the base 121, the movable element 124 does not interfere with the movement of the seating body 122.

Referring to FIG. 8, the second elastic element 1242 is connected to the rotating rod 1241 and is configured to provide a force for moving the first end 12411 toward the engaging hole 12122 of the base 121. In one embodiment, the upper shell 12211 is formed with a shaft hole (not shown), the rotating rod 1241 has a rotating shaft 1243 accommodated in the shaft hole and protruding from the rotating rod, and the second elastic element 1242 is a torsion spring sleeved on the rotating shaft 1243. One end of the torsion spring abuts against the lower shell 12212, and the other end of the torsion spring abuts against an upper surface of the rotating rod 1241.

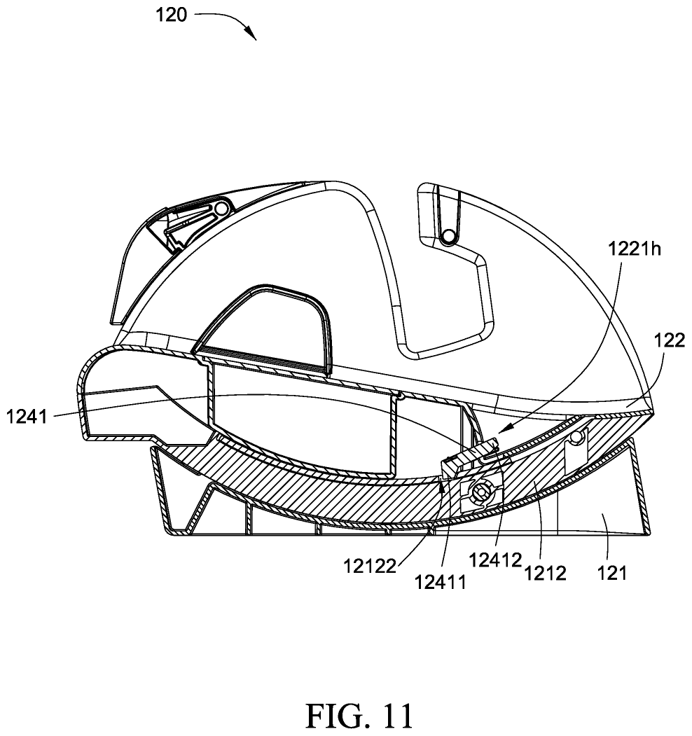

Referring to FIGS. 10 and 11, when the backrest 130 and the seating body 122 move to a predetermined position, the backrest 130 may be detached. A top surface of the seat body 1221 is formed with an installation port 1221h, and the installation port 1221h is configured to install the abutting element 136 (in combination with FIG. 1). After the backrest 130 is detached, it disengages from the abutment against the rotating rod 1241, and a part of the rotating rod 1241 is exposed through the installation port 1221h. At this time, the second elastic element 1242 exerts a force on the first end 12411 of the rotating rod 1241, so that the first end 12411 of the rotating rod 1241 is engaged with the engaging hole 12122, and the seating body 122 is locked with the base 121, preventing the seating body 122 from sliding with respect to the base 121. In detail, after the backrest 130 is removed, the abutting element 136 is separated from the rotating rod 1241 and removes the force exerted on the second end 12412 of the rotating rod 1241, and the second end 12412 of the rotating rod 1241 is exposed from the installation port 1221h. Through the elastic force of the second elastic element 1242, the first end 12411 may be engaged in the engaging hole 12122, thereby locking the seating body 122 and the base 121.

According to the child safety seat 110, only when the seating body 122 slides to the preset position with respect to the base 121, the backrest 130 and the seating body 122 may be unlocked therebetween, and the backrest 130 may be detached from the seating body 122. In other words, the backrest 130 may be detached from the seating body 122 only when the seating body 122 slides to the preset position with respect to the base 121. After the backrest 130 is detached, the backrest 130 is separated from the movable element 124 (i.e., does not abut against the movable element 124) so that the movable element 124 is locked with the base 121. At this time, the seating body 122 will not be able to slide with respect to the base 121, and the user will no longer be able to adjust the position of the seating body 122 with respect to the base 121. That is, with the mutual cooperation between the movable element 124 and the engaging hole 12122, after the backrest 130 is detached from the seating body 122, the movement of the seating body 122 is locked and cannot be moved anymore. In this way, when the child safety seat 110 is in the second mode with the backrest 130 removed, the seating body 122 will only be in the preset position, which can avoid misoperation by the user, thereby ensuring the comfort of the child in the second mode.

Referring to FIGS. 2 and 8 again, when the backrest 130 is re-installed on the seating body 122, and in combination with FIG. 1, the abutting element 136 of the backrest 130 extends into the installation port 1221h and presses against the movable element 124, and the abutting element 136 presses down the second end 12412. At the same time, the first end 12411 rotates away from the engaging hole 12122. When the backrest 130 is completely installed on the seating body 122, the first end 12411 is disengaged from the engaging hole 12122. In this way, an angle between the seating body 122 and the backrest 130 may be adjusted with respect to the base 121.

Referring to FIG. 10, a first curved sliding slot 12221, a second curved sliding slot 12222, and an opening 12223 between the first curved sliding slot 12221 and the second curved sliding slot 12222 are formed on the top of the armrest 1222. In addition, referring to FIG. 1, the backrest 130 includes a leaning part 131 and side leaning parts 132 located on both sides of the leaning part 131. A sliding part 1321 protrudes from the bottom of each of the side leaning parts 132, and the sliding part 1321 is slidably placed in the first curved sliding slot 12221. The seating assembly 120 further includes an object placement element 125, which is detachably connected to the second curved sliding slot 12222 for placing objects. In one embodiment, a cross-section of each of the first curved sliding slot 12221 and the second curved sliding slot 12222 is matched with a cross-section of the sliding part 1321. In detail, the cross-section of each of the first curved sliding slot 12221 and the second curved sliding slot 12222 is in an inverted T shape, and the cross-section of the sliding part 1321 is in an inverted T shape matching with that of the first curved sliding slot 12221.

In this embodiment, when the object placement element 125 is detached from the second curved sliding slot 12222, the sliding part 1321 sequentially slides from the first curved sliding slot 12221 to the opening 12223 and the second curved sliding slot 12222, and extends out of the second curved sliding slot 12222, thereby detaching the backrest 130 from the seating body 122. In another embodiment, a cross-section of a part of the first curved sliding slot 12221 communicating with the opening 12223 is in an inverted T shape, and a cross-section of a part of the first curved sliding slot 12221 away from the opening 12223 is in a rectangle. A cross-section of the sliding part 1321 located at a front end of the bottom of the side leaning part 132 is in an inverted T shape, and a cross section of a part away from the front end of the bottom of the side leaning part 132 is in a rectangle. In this embodiment, when the sliding part 1321 slides along the first curved sliding slot 12221 until a part of the sliding part 1321 with an inverted T-shaped cross section is completely located in the opening 12223, the user can lift the backrest 130 upward to disengage the sliding part 1321 from the first curved sliding slot 12221, and detach the backrest 130 from the seating body 122. In this embodiment, the user can detach the backrest 130 without detaching the object placement element 125.

In the embodiment as mentioned above, when the seating body 122 slides to the preset position, the avoidance slot 1214 is located below the hook part 1431 to provide a reservation space for the engaging hook 143 to rotate. The user can rotate the operating element 141 to unlock the engaging hook 143 and the engaging rod 129, and then push the backrest 130 forward along the first curved sliding slot 12221 to detach the backrest 130. It can be understood that, during the detaching process, the user does not release the operating element 141 until the hook part 1431 cannot hook the engaging rod 129 when rotating in the opposite direction, so that the backrest 130 and the seating body 122 may also remain in the unlocked state after the operating element 141 is released. When the seating body 122 is in the non-preset position, the hook part 1431 is away from the avoidance slot 1214, and the user cannot rotate the operating element 141 to unlock the hook part 1431 and the engaging rod 129, and further cannot detach the backrest 130 from the seating body 122.

As shown in FIG. 10, in this embodiment, an accommodating groove 12216 is formed on a rear edge of the seat body 1221, and the accommodating groove 12216 corresponds to the avoidance groove 1214 of the base 121. When the seating body 122 slides to the preset position, the avoidance slot 1214 at least partially overlaps with the accommodating groove 12216. Accordingly, after the backrest 130 is detached, the avoidance slot 1214 of the base 121 is exposed from the accommodating groove 12216. When the backrest 130 is re-installed on the seating body 122, the locking element 140 of the backrest 130 is placed in the accommodating groove 12216, and the hook part 1431 of the engaging hook 143 engages with the engaging rod 129 of the seating body 122 (see FIG. 6) to lock the backrest 130 and the seating body 122.

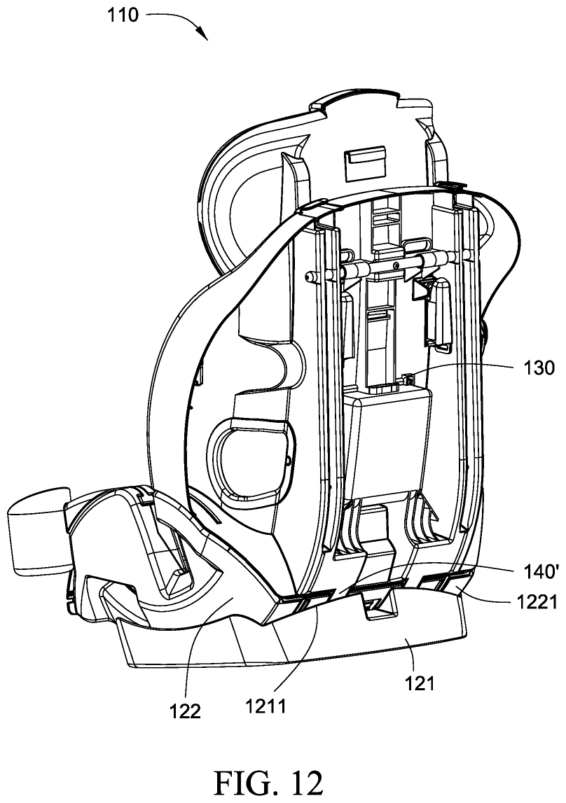

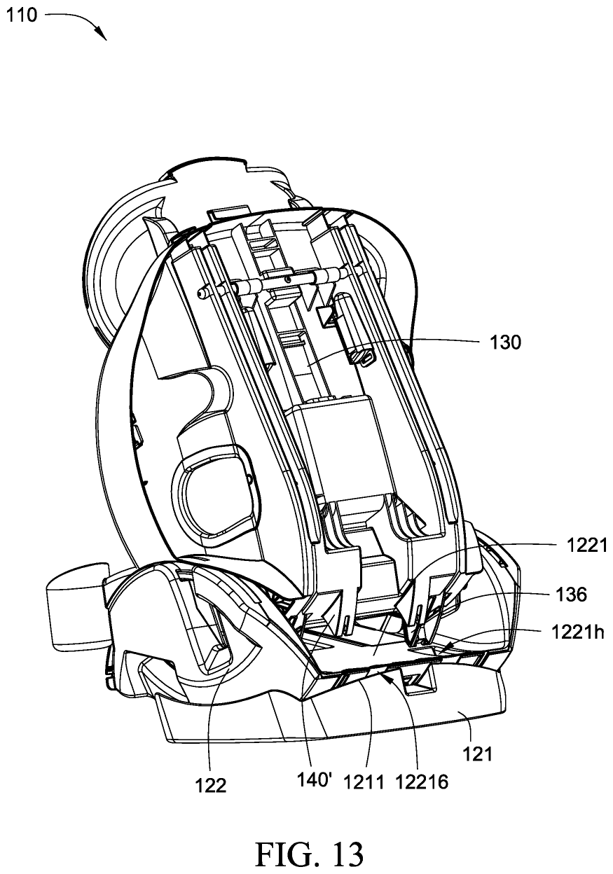

Referring to FIGS. 12 and 13, in another embodiment, a locking element 140′ is fixed on a bottom end of the backrest 130, and the accommodating groove 12216 is formed on the rear edge of the seat body 1221 toward the base 121. The locking element 140′ is placed in the accommodating groove 12216, an end of the locking element 140′ slides along the curved top surface 1211 of the base 121 with the seat body 1221. The accommodating groove 12216 may be a curved groove, and the locking element 140′ is attached between the curved groove and the curved top surface 1211. The rear edge of the base 121 is formed with an avoidance slot (not shown) facing the backrest 130, and the locking element 140′ is opposite to the avoidance slot when the seating body 122 is positioned at the preset position.

In the above embodiment, when the seating body 122 is positioned at the preset position and the user pushes the backrest 130 forward, the avoidance slot is located below the locking element 140′, providing a reservation space for the locking element 140′ to rotate. Thus, when the backrest 130 slides along the first curved sliding slot 12221 to move the backrest 130 upward and rotate at the same time, the locking element 140′ may rotate away from the base 121 and disengage from the accommodating groove 12216, thereby detaching the backrest 130 from the seating body 122. When the seating body 122 is positioned at the non-preset position and the user pushes the backrest 130 forward, the locking element 140′ is located in the curved top surface 1211 and abuts against the curved top surface 1211, thereby preventing the backrest 130 from sliding along the first curved sliding slot 12221, and preventing the backrest 130 from being detached from the seating body 122.

According to one embodiment, a seating assembly 120 as described above is provided for detachable connecting with the backrest 130. The seating assembly 120 includes a base 121, a seating body 122, an adjustment assembly 123 connected between the base 121 and the seating body 122, and a movable element 124 connected between the backrest 130 and the seating body 122. The seating body 122 is slidably connected to the base 121 and may be positioned at different positions with respect to the base 121 by the user operating the adjustment assembly 123. When the seating body 122 does not slide to the preset position with respect to the base 121, the locking element 140, 140′ is away from the corresponding avoidance slot. The rotation of the locking element 140, 140′ will interfere with the base 121, and the locking element 140, 140′ will not be unlocked by the user, so that the backrest 130 cannot move with respect to the seating body 122, and the backrest 130 cannot be detached from the seating body 122. When the seating body 122 slides to the preset position with respect to the base 121, the corresponding avoidance slot is located below the locking element 140, 140′, providing a reservation space for the locking element 140, 140′ to rotate, and the locking element 140, 140′ may be unlocked by the user, the backrest 130 may move with respect to the seating body 122, and then the backrest 130 may be detached from the seating body 122.

In addition, after the backrest 130 is detached, the movable element 124 is disengaged from the backrest 130 and locked with the base 121, thereby locking the movement of the seating body 122. The above-mentioned seating assembly 120 allows the backrest 130 to be detached only when the seating body 122 slides with respect to the base 121 to the preset position, and after the backrest 130 is detached, the seating body 122 and the base 121 are fixed, thereby maintaining the seating body 122 at the preset position to provide a comfortable riding experience for the children in the usage mode without the backrest provided.

Further, in order to solve the problems in the prior art, there is an urgent need for a foldable child safety seat with simple structure, convenient operation and high safety level, in particular to a folding mechanism of the child safety seat, so that the child safety seat can be folded when not in use, thereby reducing space occupancy rate and transportation cost.

An embodiment of a second aspect of the present disclosure provides a foldable child safety seat.

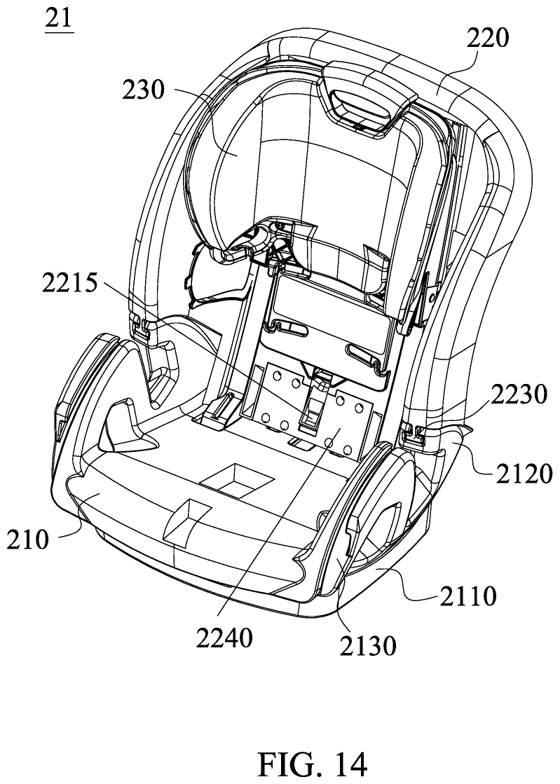

Referring to FIG. 14, FIG. 14 shows a perspective view of a child safety seat according to an embodiment of the present disclosure. The child safety seat 1 includes a seat part 210 (similar to the “seat body 1221” as described in the first aspect of the present disclosure), a backrest 220 and a folding mechanism for folding the child safety seat. Specifically, the folding mechanism may fold a backrest 220 of the child safety seat 21 with respect to the seat part 210, so that the entire seat may be folded. In addition, the child safety seat 21 may further include a headrest 230, and the headrest 230 is disposed on the backrest 220 and may be adjusted in a longitudinal direction.

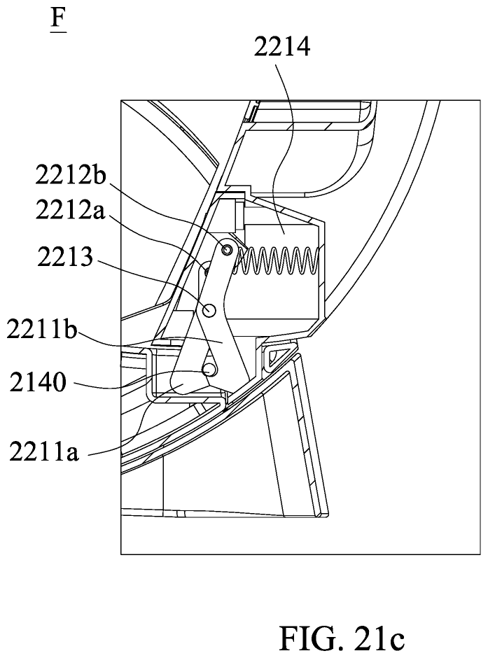

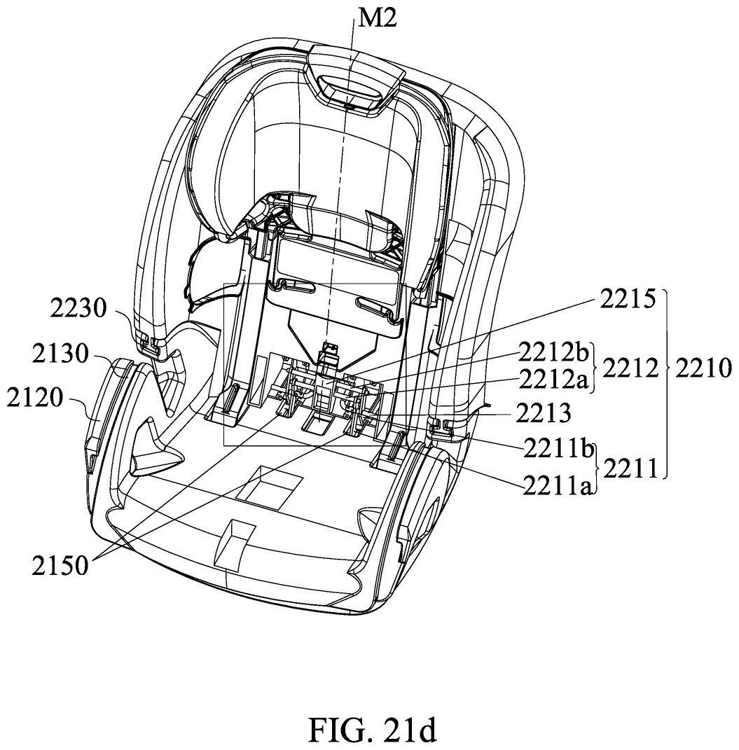

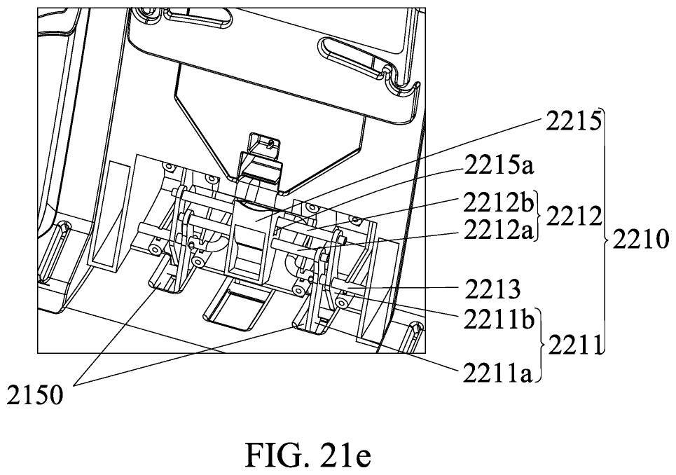

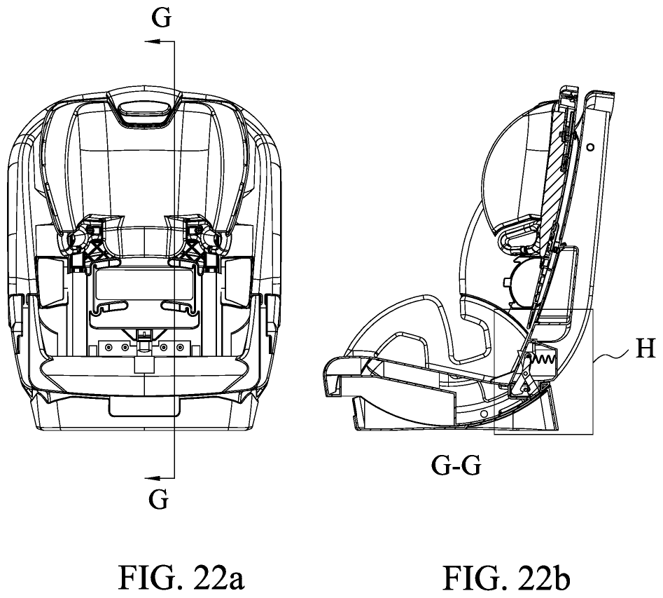

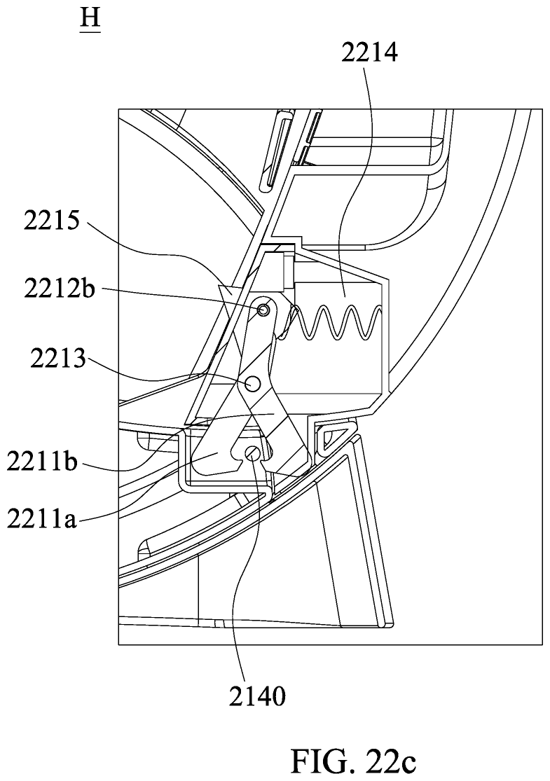

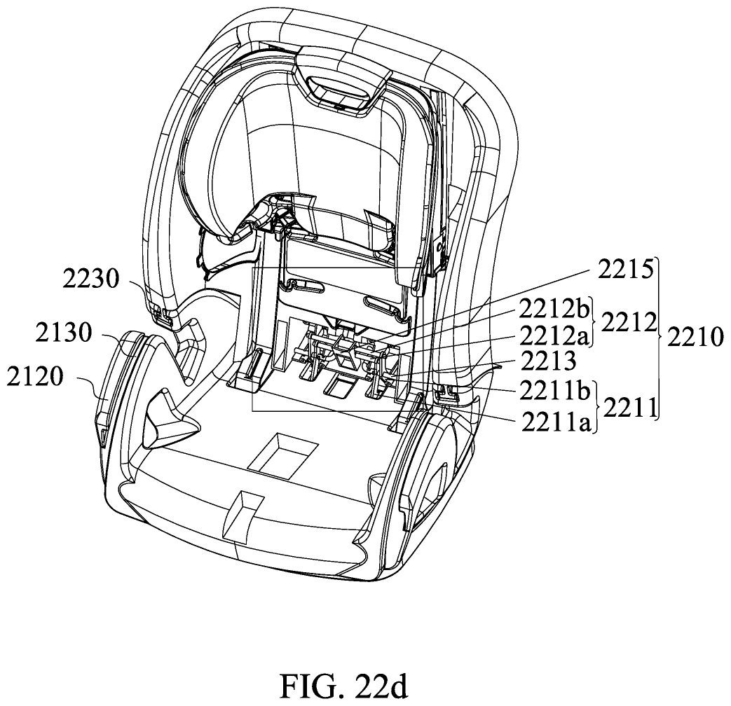

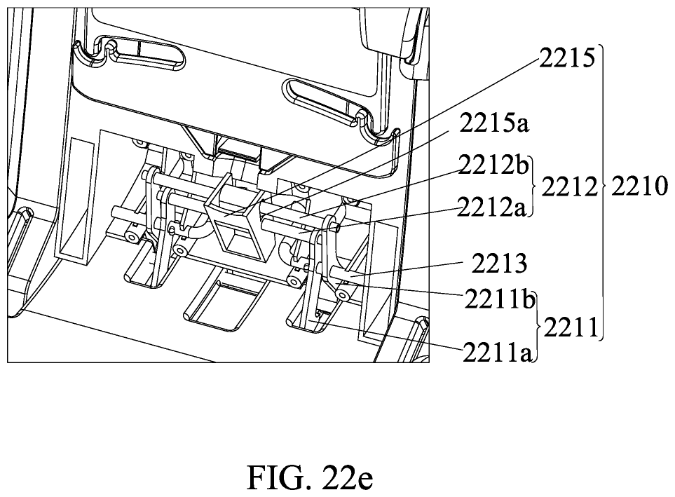

As shown in FIG. 14, the folding mechanism of the child safety seat 21 of the present disclosure includes a sliding groove 2130, a sliding rib 2230, and a locking structure (the locking structure in FIG. 14 is covered by a cover plate 2240, and only an operating element 2215 thereof is exposed, for the specific structure of the locking structure, please see FIGS. 21d and 22d and it will be described later). The sliding groove 2130 is disposed on one of the seat part 210 and the backrest 220, and the sliding rib 2230 is disposed on the other of the seat part 210 and the backrest 220. For convenience of explanation, an example that the sliding groove 2130 is disposed on the seat part 210 and the sliding rib 2230 is disposed on the backrest 220 is taken, but the present disclosure is not limited thereto.

In one embodiment, the sliding groove 2130 is disposed on each of both sides of the seat part 210, and the sliding rib 2230 is disposed on each of both sides of the backrest 220 (for example, on a side wing at each side of the backrest 220). Specifically, the sliding groove 2130 is disposed on a top surface of an armrest 2120 at each of both sides of the seat part 210, while the sliding rib 2230 is disposed on a bottom surface of each of two side wings of the backrest 220 and corresponds to the sliding groove 2130 on the seat part 210, for example, a position of the sliding rib 2230 corresponds to a position of the sliding groove 2130 in a lateral direction, for cooperation and connection with each other. In addition, the sliding rib 2230 and the sliding groove 2130 have complementary structure, such as complementary T shapes, i.e., the sliding rib 2230 and the sliding groove 2130 have corresponding structures that are complementary to each other, wherein a cross section of the sliding groove 2130 has an inverted T shape. However, the present disclosure is not limited thereto, that is, the sliding rib 2230 and the sliding groove 2130 may also have other shapes and may cooperate with each other and slide with respect to each other.

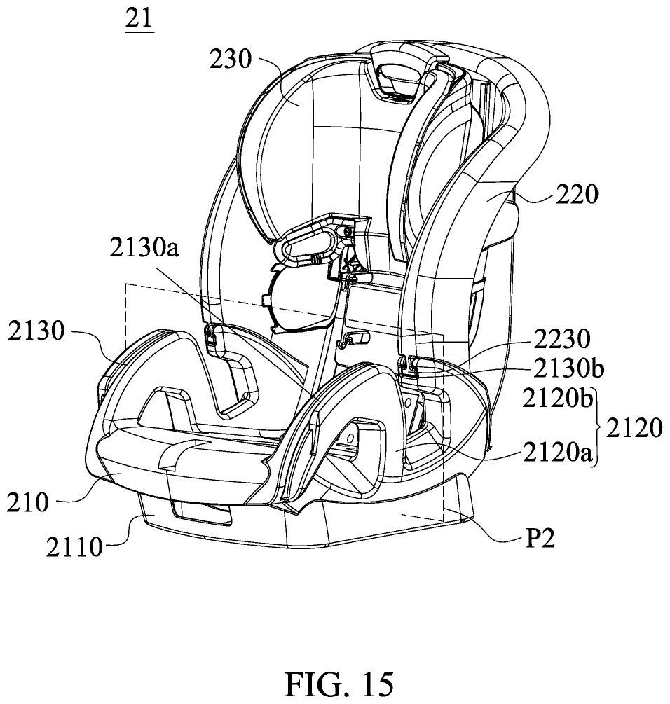

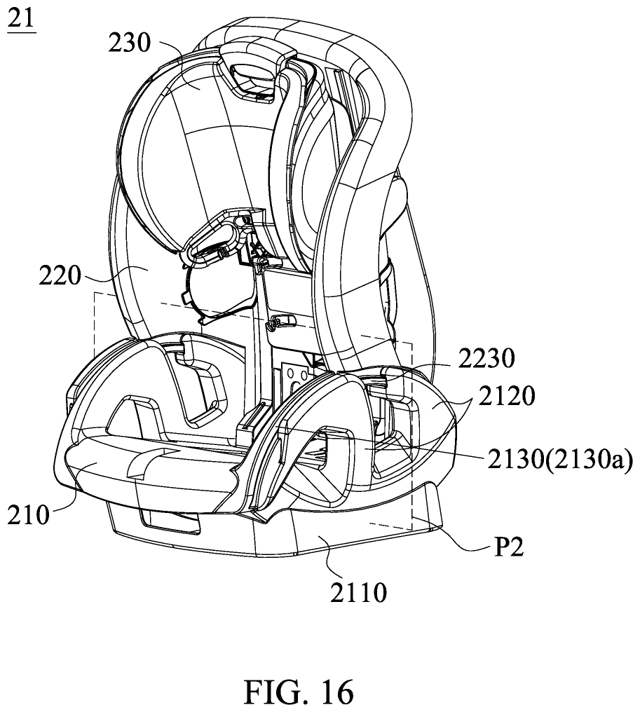

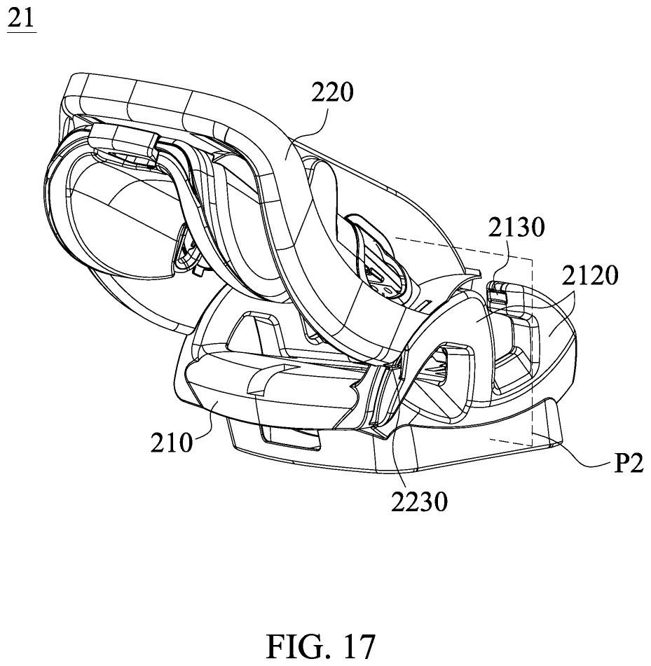

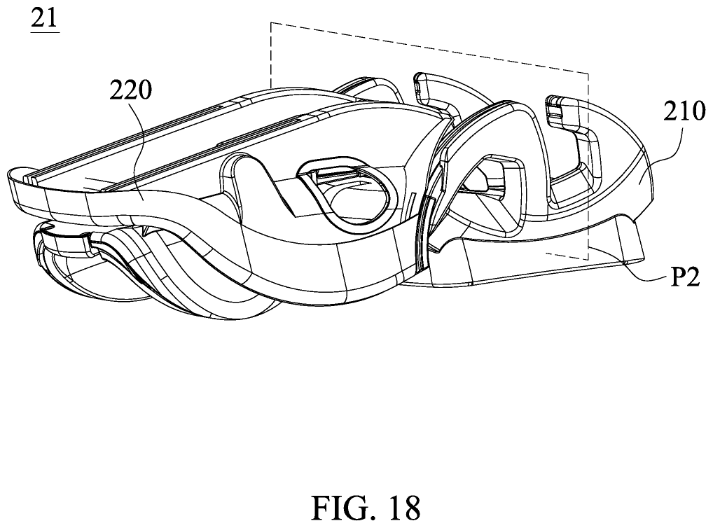

FIGS. 15 to 18 respectively show different stages (processes) of the child safety seat 21 from an unfolded state to a fully folded state according to an embodiment of the present disclosure. FIG. 15 shows the child safety seat 21 before being folded (that is, in the unfolded state), FIGS. 16 and 17 show the child safety seat 21 during being folded, and FIG. 18 shows the child safety seat 21 in the fully folded state.

As shown in FIG. 15, when the backrest 220 is locked with respect to the seat part 210 and in the unfolded state, the child safety seat 21 is in a use state, an angle of the backrest 220 with respect to the seat part 210 is greater than or equal to 90 degrees, and the backrest 220 and the seat part 210 cannot move relatively, to ensure the safety of riding.

Referring to FIGS. 16 to 18 again, when the backrest 220 is unlocked from the seat part 210, a lower end of the backrest 220 may be separated from the seat part 210, and the backrest 220 may entirely slide with respect to the seat part 210 by means of the sliding fit between the sliding groove 2130 and the sliding rib 2230, so as to be folded with respect to the seat part 210. Specifically, the sliding ribs 2230 on both sides of the backrest 220 may slide forward along the corresponding sliding grooves 2130 on both sides of the seat part 210, so that the backrest 220 and the seat part 210 gradually approach to each other (as shown in FIGS. 16 and 17) until the child safety seat 21 is completely folded to the folded state (as shown in FIG. 18).

Through the cooperation between the sliding ribs 2230 on both sides of the backrest 220 and the sliding grooves 2130 on both sides of the seat part 210, the backrest 220 can be stably folded when the backrest 220 slides with respect to the seat part 10, and a stable connection can be provided when the child safety seat is in the unfolded state, so as to avoid the backrest 220 from shaking laterally with respect to the seat part 210.

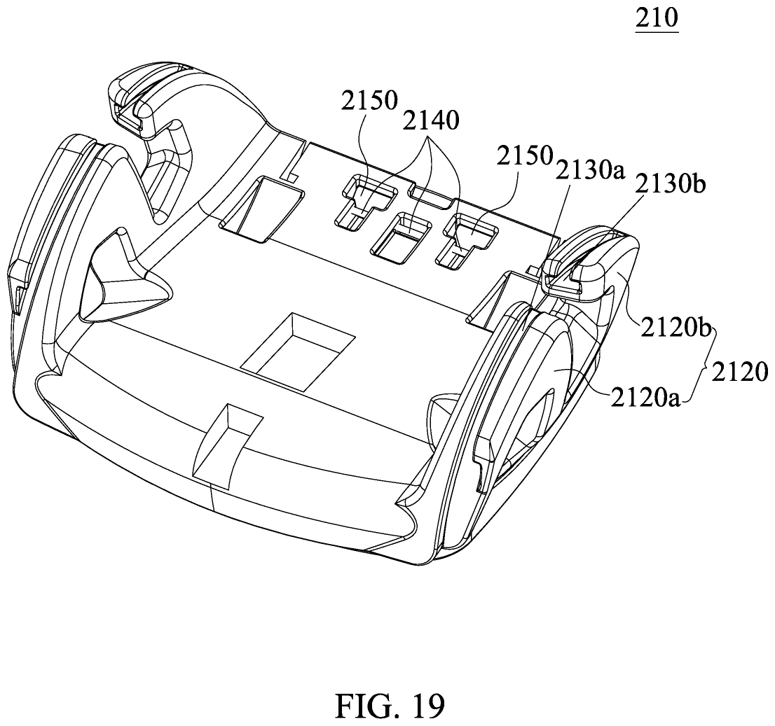

FIG. 19 shows a perspective view of the seat part 210 of the child safety seat 1 according to an embodiment of the present disclosure. As shown in FIG. 19, the armrest 2120 on each of both sides of the seat part 210 may include a front armrest 2120a and a rear armrest 2120b spaced apart from each other. In the case that a three-point safety belt of the vehicle is used for the child safety seat, the safety belt may pass through a gap between the front armrest 2120a and the rear armrest 2120b, to fix and protect the children sitting in the child safety seat. For a child safety seat in which a three-point seat belt is not used, the front armrest 2120a and the rear armrest 2120b may be integrated without the gap.

Referring to FIGS. 15 to 18, a virtual vertical plane P2 is defined between the front armrest 2120a and the rear armrest 2120b. The virtual vertical plane P2 is located in the gap between the front armrest 2120a and the rear armrest 2120b in a front-rear direction and perpendicular to the base 2110. As shown in FIG. 15, when the child safety seat 21 is in the unfolded state, that is, when the backrest 220 is locked with respect to the seat part 210, the sliding rib 2230 is located in the rear sliding groove 2130b of the rear armrest 2120b, that is, the backrest 220 is entirely located at a rear side of the virtual vertical plane P2 (that is, one side of the rear armrest 2120b), and the angle of the backrest 220 with respect to the seat part 210 is greater than or equal to 90 degrees; while when the backrest 220 is unlocked with respect to the seat part 210 and the child safety seat 1 begins to be folded, as shown in FIGS. 16 and 17, the backrest 220 begins to be folded (approach) with respect to the seat part 210, and the sliding rib 2230 slides (which in turn drives the backrest 220 to move) forward along the rear sliding groove 2130b of the rear armrest 2120b and gradually passes through the virtual vertical plane P2, then crosses over the gap between the rear armrest 2120b and the front armrest 2120a, and slides into the front sliding groove 2130a of the front armrest 2120a (i.e., the angle of the backrest 220 with respect to the seat part 210 is less than 90 degrees) and continues to move forward along the front armrest 2120a until the sliding rib 2230 is completely located in the front sliding groove 2130a of the front armrest 2120a, and the backrest 220 is folded with respect to the seat part 210, so that the child safety seat 21 is in the folded state (i.e., the fully folded state), at the same time, the entire backrest 220 is located at a front side of the virtual vertical plane P2.

In addition, a front end of the sliding groove 2130 on the armrest 2120 at each of both sides of the seat part 210 may be opened. In particular, a notch may be provided at an outer side on a front end of the front sliding groove 2130a. When the child safety seat 21 is completely folded (as shown in FIG. 18), the sliding rib 2230 is located in the gap. At this time, the backrest 220 may be removed from the seat part 210 by pulling the side wings of the backrest 220 outward. After the backrest 220 is removed, the seat part 210 may be independently used as a “No-back Booster”. Furthermore, a rear side of the rear sliding groove 2130b is closed, to prevent the backrest 220 from sliding backward with respect to the seat part 210 when it reaches a position in which it is in the unfolded state, thereby further improving the connection reliability between the backrest 220 and the seat part 210 and the use safety of the child safety seat.

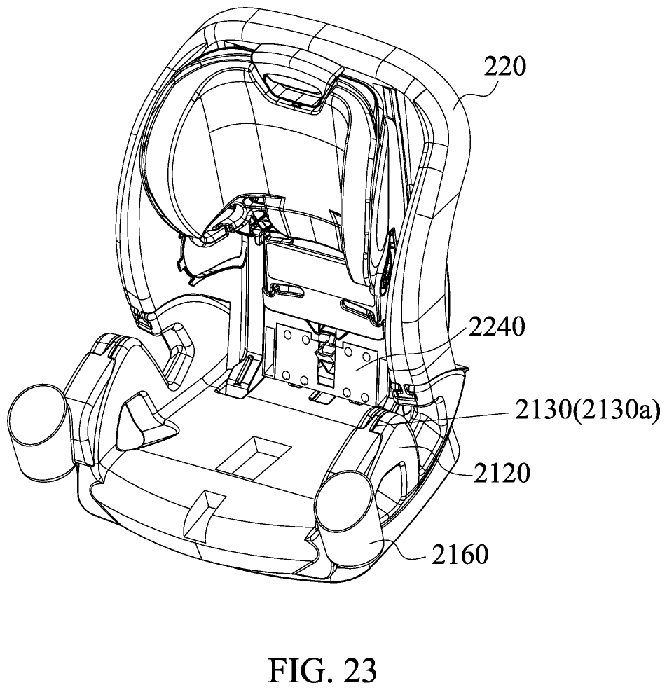

In one embodiment, as shown in FIG. 23, the child safety seat 21 further includes a storage device 2160 detachably installed to the sliding groove 2130 of the seat part 210. For example, a storage cup may be installed on the front side of the armrest 2120, and the storage cup may be detachably inserted into the sliding groove 2130 to cover the sliding groove 2130, so that the child safety seat 21 is more aesthetic, and foreign objects can be prevented from sliding into the sliding groove 2130 to block the sliding rib 2230 from sliding in the sliding groove 2130 or make the sliding uneven. When the seat needs to be folded, it is necessary to remove the storage device first.

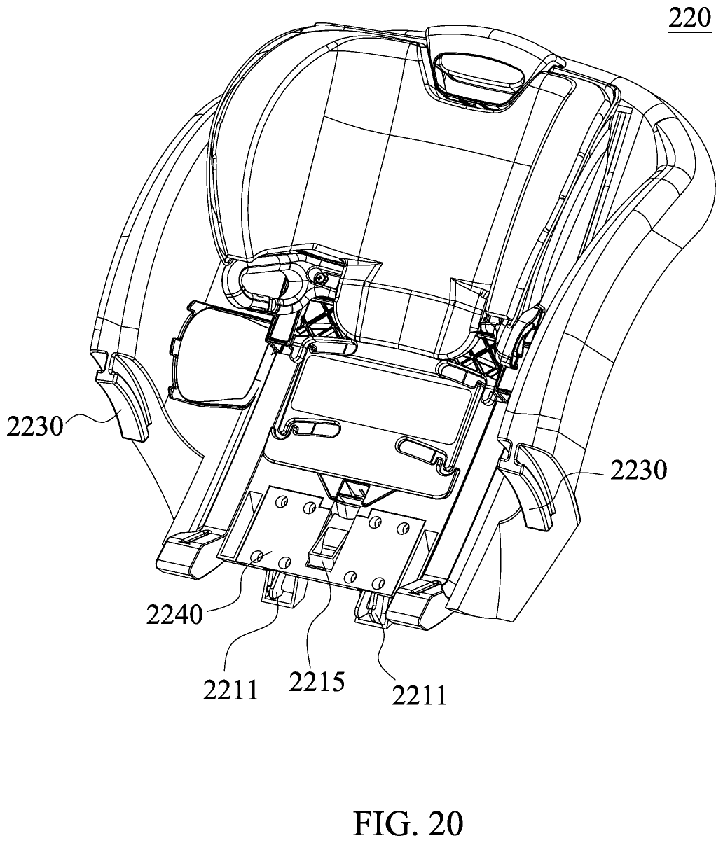

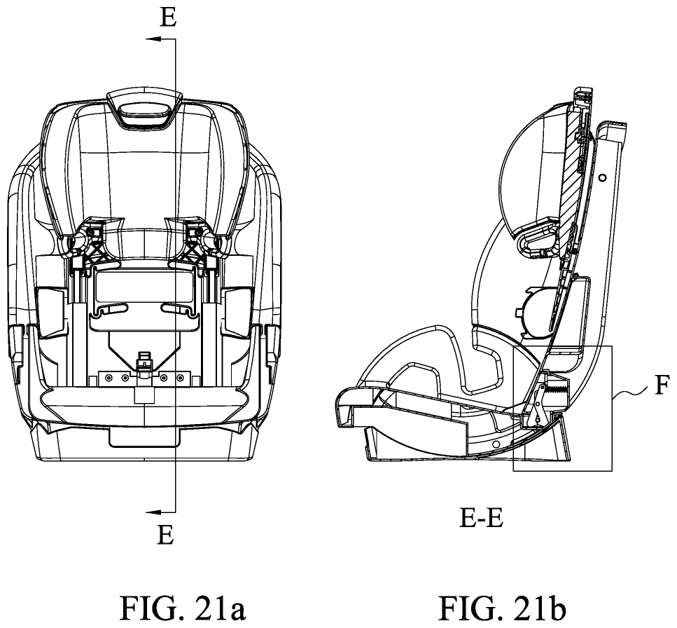

Hereinafter, a locking structure 2210 for locking and unlocking between the backrest 220 and the seat part 210 will be described with reference to FIGS. 20 to 22e in combination with FIG. 19. FIG. 20 shows a perspective view of the backrest 220 of the child safety seat 21 according to an embodiment of the present disclosure, FIGS. 21a to 21d respectively show views of the child safety seat 21 when the locking structure 2210 is in a locking position, and FIGS. 22a to 22d respectively show views of the child safety seat when the locking structure is in an unlocking position.

Referring to FIGS. 19, 20, 21d and 22d, the locking structure 2210 is disposed on a lower side of the backrest 220 and is operated to switch between the locking position and the unlocking position. The locking structure 2210 is in the locking position when it is engaged with an engaging rod 2140 fixed to the seat part 210, so that the backrest 220 is locked with respect to the seat part 210; while the locking structure 2210 is in the unlocking position when it is disengaged from the engaging rod 2140, so that the backrest 220 can be moved and folded with respect to the seat part 210.

Specifically, as shown in FIG. 21d, the locking structure 2210 includes a locking hook assembly 2211, a connecting rod 2212 and an operating element 2215. Referring to FIG. 14, when the backrest 220 and the seat part 210 are assembled and locked together, the operating element 2215 is at least partially exposed to the backrest 220 for convenience of operation. The locking hook assembly 2211 and the connecting rod 2212 are located in the backrest 220 and covered by the cover plate 2240, which can prevent dust or foreign objects from entering and prevent the users or children from accidentally putting their hands into the backrest and being injured. Meanwhile, when maintenance or service is needed, the cover plate 2240 may be opened to check whether the internal structure is abnormal, so that maintenance and operation costs can be saved.

As shown in FIGS. 20, 21d and 22d, the locking hook assembly 2211 is pivotally connected to the fixing rod 2213 of the backrest 220, and protrudes from a bottom side of the backrest 220 and into the seat part 210 through the locking hole 2150 on an upper surface of the seat part 210, so that when the locking structure 2210 is in the locking position, the locking hook assembly 2211 is engaged with the locking rod 2140 fixed in the seat part 210. The connecting rod 2212 is connected between the locking hook assembly 2211 and the operating element 2215, wherein the connecting rod 2212 is fixedly connected with the locking hook assembly 2211 and movably connected with the operating element 2215, so that the locking hook assembly 2211 may be disengaged from the engaging rod 2140 by operating the operating element 2215.

In one embodiment, as shown in FIGS. 21c to 21e, the locking hook assembly 2211 includes a first locking hook 2211a and a second locking hook 2211b, wherein one end of each of the first locking hook 2211a and the second locking hook 2211b is connected with the operating element 2215 through a corresponding one of two connecting rods 2212 (i.e., a first connecting rod 2212a corresponding to the first locking hook 2211a and a first connecting rod 2212b corresponding to the second locking hook 2211b). The other end of each of the first locking hook 2211a and the second locking hook 2211b is in a hook shape, and the hook shapes of the other ends are opposite to each other. For example, the hook shape is formed as a pair of pliers as shown in FIG. 21c, and middle parts of the first locking hook 2211a and the second locking hook 2211b are pivotally connected to the fixing rod 2213, respectively.

In addition, two connecting rods 2212 (i.e., a first connecting rod 2212a and a second connecting rod 2212b) are disposed up and down with respect to the operating element 2215, that is, one of the two connecting rods 2212 is disposed at an upper portion of the operating element 2215, and the other of the two connecting rods 2212 is disposed at a lower portion of the operating element 2215. For example, as shown in FIGS. 21e and 22e, the connecting rod 2212a at the lower portion is pivotally connected with the operating element 2215, while the connecting rod 2212b at the upper portion is pivotally and slidably connected with the operating element 2215, so that the linkage relationship between the operating element 2215 and the locking hook assembly 2211 can be realized, and the locking hook assembly 2211 is smoothly driven to switch between the locking position and the unlocking position through the operating element 2215.

In one embodiment, as shown in FIG. 21d, the locking structure 2210 includes two locking hook assemblies 2211 that are symmetrically disposed with respect to a central axis M2 of the backrest 220. The operating element 2215 may be disposed at the central axis of the backrest 220, and the connecting rod 2212 penetrates into the operating element 2215 and has two ends respectively connected to two locking hook assemblies 2211 that are symmetrically disposed in a longitudinal direction, so that the two locking hook assemblies 2211 may move synchronously.

In addition, as shown in FIGS. 21c and 22c, the folding mechanism of the present disclosure further includes an elastic restoring element 2214. One end of the elastic restoring element 2214 is fixed to a frame of the backrest 220, and the other end of the elastic restoring element 2214 is fixed to the locking structure 2210 (for example, the operating element 2215, the locking hook assembly 2211 or the connecting rod 2212), to apply a force to make the locking structure 2210 in the locking position, so that the locking between the backrest 220 and the seat part 210 may be more stable and reliable. For example, the elastic restoring element 2214 may be a restoring tension spring, and one end of the restoring tension spring is disposed on one of the locking hooks or the connecting rods of the locking hook assembly to apply a force to pull the locking hook or the connecting rod to the locking position; or alternatively, the elastic restoring element 2214 may be a restoring compression spring, and one end of the restoring compression spring is provided on the operating element 2215 to apply a force to press the operating element back to its initial state (i.e., the locking structure is in the locking position). Hereinafter, an example will be described in which the elastic restoring element 2214 is disposed on the second locking hook 2211b or the second connecting rod 2212b connected with the second locking hook 2211b.

In order to facilitate the understanding of the working principle of the present disclosure, the switching process of the locking structure 2210 between the locking position and the unlocking position according to an embodiment of the present disclosure will be described in detail with reference to FIGS. 21a to 21e and 22a to 22e.

First, referring to FIGS. 21a to 21e, FIG. 21a shows a front view of the child safety seat 21 when the child safety seat 21 is in a use state and the locking structure 2210 is in the locking position, and FIG. 21b shows a sectional view taken along the line E-E in FIG. 21a, FIG. 21c shows a partial enlarged view at a block F shown in FIG. 21b, FIG. 21d shows a perspective view of the child safety seat when the locking structure 2210 is in the locking position, and FIG. 21e shows a partial enlarged view of the locking structure 2210 in FIG. 21d.

As shown in FIGS. 21d and 21e, the locking structure 2210 includes a locking hook assembly 2211, a connecting rod 2212 and an operating element 2215. The locking hook assembly 2211 includes a first locking hook 2211a and a second locking hook 2211b. The connecting rod 2212 includes a first connecting rod 2212a and a second connecting rod 2212b. The first connecting rod 2212a is connected with an upper end of the first locking hook 2211a. The second connecting rod 2212b is connected with an upper end of the second locking hook 2211b. A lower end of the first locking hook 2211a and a lower end of the second locking hook 2211b have hook structures opposite to each other. The first locking hook 2211a is located at a front side of the second locking hook 2211b, the first connecting rod 2212a is located at a lower side of the second connecting rod 2212b, and the first connecting rod 2212a is pivotally connected with the operating element 2215. The second connecting rod 2212b is pivotally and slidably connected with the operating element 2215. For example, as shown in FIG. 21e, the operating element 2215 has a connecting groove 2215a penetrating through the operating element 2215 along its width direction to be able to pivot and/or slide with respect to the operating element 2215. The connecting groove 2215a has a length along a length direction of the operating element 2215, and the second connecting rod 2212b may penetrate through the connecting groove 2215 and has a sliding stroke corresponding to the length of the connecting groove 2215a. Further, as shown in FIG. 21c, the locking structure 2210 further includes an elastic restoring element 2214. One end of the elastic restoring element 2214 (for example, a restoring tension spring) is fixed to the frame of the backrest 220, and the other end of the elastic restoring element 2214 is connected to the second locking hook 2211b or the second connecting rod 2212b. The elastic restoring element 2214 constantly applies a pulling force so that the first locking hook 2211a and the second locking hook 2211b are always engaged.

As shown in FIGS. 21c, 21d and 21e, when the locking structure 2210 is in the locking position, the first locking hook 2211a and the second locking hook 2211b are respectively engaged with the engaging rod 2140 fixed on the seat part 210 from two sides, and the second connecting rod 2212b is limited to one end of the sliding stroke of the connecting groove 2215a, for example, an end of the connecting groove 2215a close to the outside of the operating element 2215 as shown in FIG. 21e, to lock the backrest 220 to the seat part 210. More specifically, as shown in FIG. 21c, a main part of the first locking hook 2211a and a main part of the second locking hook 2211b may be assembled into a shape similar to “X” in a mirror symmetrical manner. In the locking position, the first connecting rod 2212a connected to the upper end of the first locking hook 2211a is relatively away from the second connecting rod 2212b connected to the upper end of the second locking hook 2211b in the horizontal direction. However, the first locking hook 2211a and the second locking hook 2211b may have other shapes, and the present disclosure is not limited thereto.

Furthermore, referring to FIGS. 22a to 22e, FIG. 22a shows a front view when the locking structure 2210 is in the unlocking position and the child safety seat 21 has not been folded, FIG. 22b shows a sectional view taken along line G-G in FIG. 22a, FIG. 22c shows a partial enlarged view at a block H shown in FIG. 22b, FIG. 22d shows a perspective view of the child safety seat 1 when the locking structure 2210 is in the unlocking position, and FIG. 22e shows a partial enlarged view at the locking structure 2210 in FIG. 22d.

As shown in FIGS. 22c, 22d and 22e, when the backrest 220 needs to be unlocked and be folded with respect to the seat part 210, the lower end of the operating element 2215 is pushed to pivot the lower end thereof inward and the upper end thereof outward, so that the second connecting rod 2212b slides in the connecting groove 2215a along the sliding stroke (as shown in FIG. 22e) and approaches the first connecting rod 2212a (as shown in FIG. 22c) to drive the first locking hook 2211a and the second locking hook 2211b (especially the lower end of the first locking hook 2211a and the lower end of the second locking hook 2211b) to pivot and move away from each other, so as to disengage from the engaging rod 2140. At this time, the backrest 220 may be folded with respect to the seat part 210 through the cooperation of the sliding groove and the sliding rib. It can be understood that the locking structure 2210 may also be disposed in the seat part 210 and the engaging rod 2140 may be disposed on the backrest 220.

When the operation (e.g., pushing) of the operating element 2215 is released, the elastic restoring element 2214, such as the restoring tension spring shown in FIG. 22c, pulls the second connecting rod 2212b (or the upper end of the second locking hook 2211b), in this way, the second connecting rod 2212b moves away from the first connecting rod 2212a, and the first locking hook 2211a and the second locking hook 2211b return to their initial positions, for example, their lower ends are close to each other. That is, when the backrest 220 are not movable with respect to the seat part 210, the first locking hook 2211a and the second locking hook 2211b are re-engaged with the engaging rod 2140, thereby returning to the locking position as shown in FIG. 21c.

Through the cooperation of the sliding groove and the sliding rib, and the locking and unlocking of the locking structure between the seat part and the backrest, the folding mechanism of the child safety seat can not only realize the folding and disassembling of the backrest with respect to the seat part, but also realize the stable connection in the lateral direction and the longitudinal direction, and improve the use safety and reliability. Moreover, the folding mechanism has simple structure and convenient operation, and the child safety seat can be folded when it is not in use, so that the space occupancy rate and the transportation cost can be reduced.

The child safety seat and the folding mechanism thereof have the following beneficial technical effects:
The folding mechanism has a simple structure that is easy to operate and convenient for disassembly and assembly. The folding of the backrest with respect to the seat can be realized through the sliding fit between the seat part and the backrest, so that the volume of the folded child safety seat is small, and then the overall packaging can also be reduced, the transportation cost without occupying much space of the vehicle can be reduced, and it is not necessary for the users to disassemble and carry the entire child safety seat repeatedly to make room, and then the use convenience can be improved.

In addition, the connection between the backrest and the seat is more stable in the child safety seat of the present disclosure through the cooperation between the sliding ribs at both sides of the backrest (or the seat part) and the sliding grooves at both sides of the seat part (or the backrest), the lateral (i.e. in the left-right direction) shaking during traveling of the vehicle can be avoided; and the locking hook is engaged with the engaging rod fixed on the seat, so that the connection strength between the backrest and the seat part can be increased, the child safety seat has good strength when being used forward or backward, the stability of the child safety seat in the longitudinal direction can also be enhanced, and the use safety can be further ensured.

In addition, a third aspect of the present disclosure provides a seat.

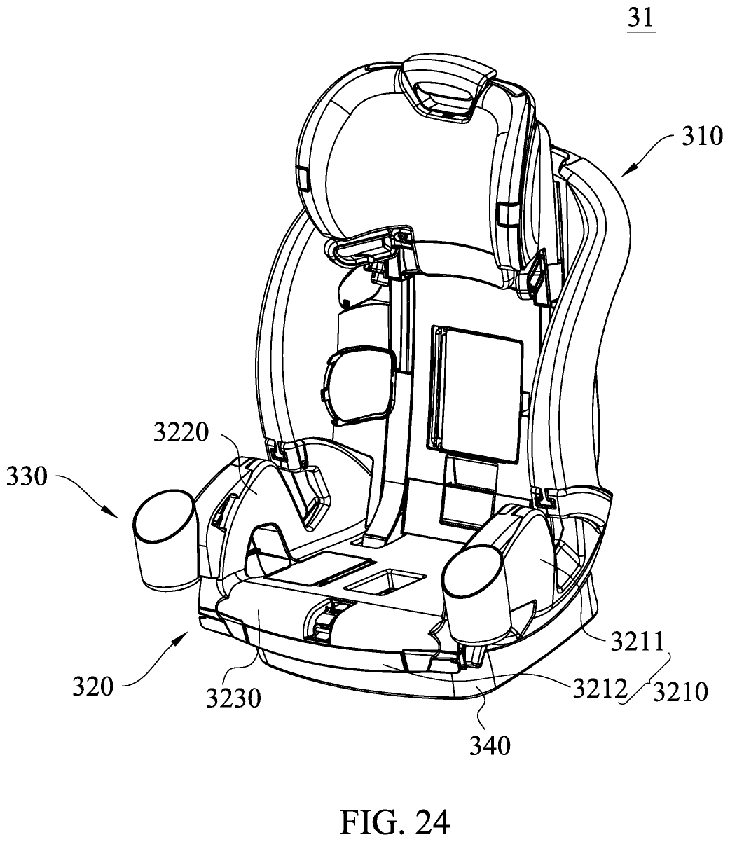

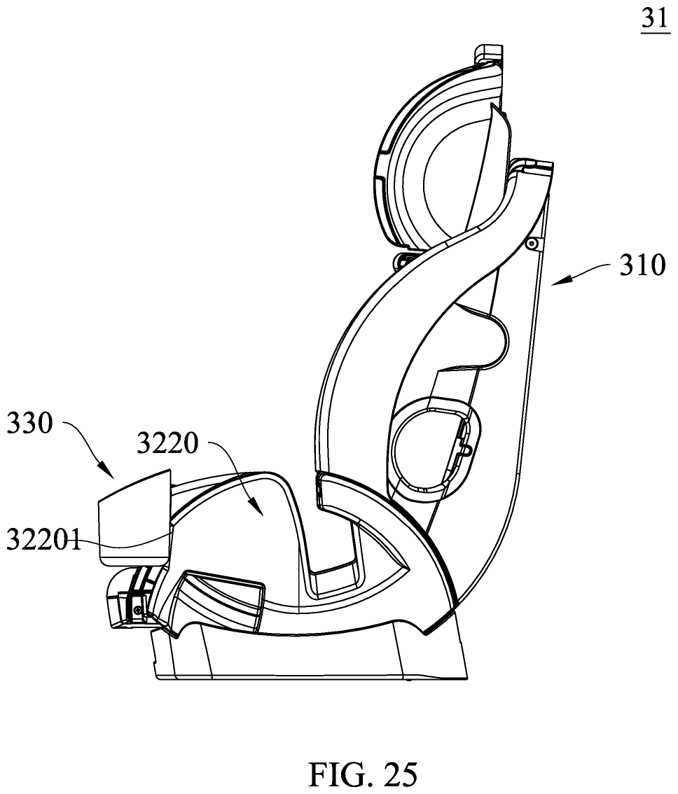

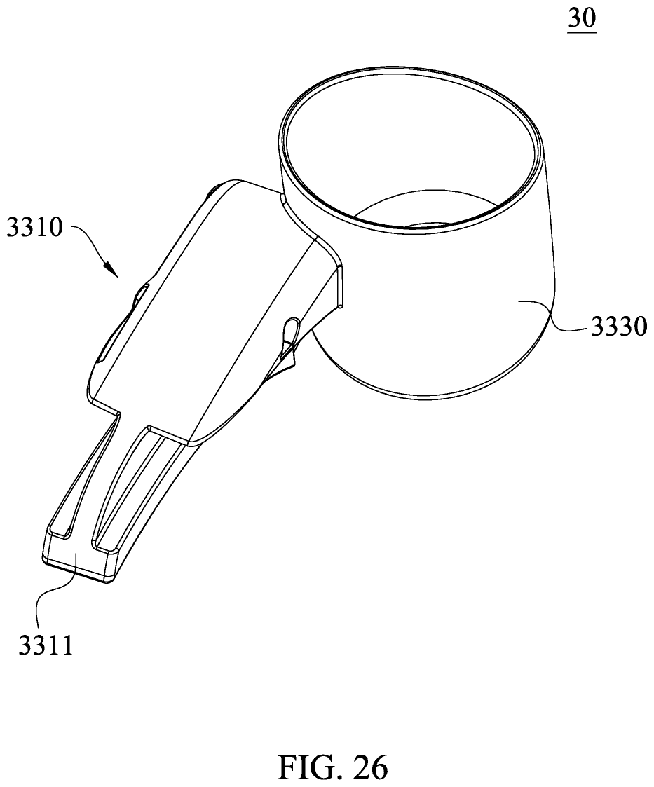

Referring to FIGS. 24 and 25, a perspective view and a side view of the seat 31 according to an embodiment of the present disclosure are schematically shown respectively.

Referring to FIG. 24, the seat 31 of this embodiment includes a backrest 310, a seat part 320, and a storage device 330. The backrest 310 is detachably installed on the seat part 320. When the seat 31 is used, the backrest 310 may be provided substantially perpendicular to the seat part 320, or an angle of the backrest 310 with respect to the seat part 320 may be adjusted within a certain range. When the seat 31 is not in use, the backrest 310 may be folded with respect to the seat part 320 (not shown) to reduce a volume of the entire seat and facilitate storage. The seat 31 may further include a base 340 disposed below the seat part 320 and configured to support and position the entire seat 31 on a vehicle seat. Optionally, the seat 31 of this embodiment is a child safety seat.

As shown in FIG. 24, an armrest 3220 is provided on each of both sides of the seat part 320. For example, the seat part 320 includes a seat part body 3230 and a housing 3210. The housing 3210 includes two side covers 3211 and a bottom cover 3212. Each of the two side covers 3211 is fixedly connected to an outer side of an upright portion on a corresponding one of left and right sides of the seat part body 3230, and form an armrest 3220 with the corresponding upright portion. The bottom cover 3212 is fixedly connected between the base 340 and the seat part 320. More specifically, as shown in FIG. 24, the bottom cover 3212 is fixedly connected to the seat part body 3230 and the side covers 3211 on both sides respectively to form the appearance of the seat part 320.

In addition, a storage device 330 is provided on at least one armrest 3220 of the seat part 320. The storage device 330 may be slidably connected to the seat 31, such as its seat part 320, in a front-rear direction (i.e., forward and rearward). For example, as shown in FIG. 24, the storage device 330 may be installed on the armrest 3220 of the seat part 320 from the front of the seat in a direction toward the backrest 310, or may be detached from the armrest 3220 in a direction away from the backrest 310. More specifically, the storage device 330 may slide along an upper edge of the armrest 3220. In one embodiment, a detachable storage device 330 is provided on each of the two armrests 3220. For example, the storage device 330 may be a storage cup. The specific structure of the storage device 330 will be described below in combination with FIG. 26.

Referring to FIG. 25, when the storage device 330 is installed on the armrest 3220 of the seat part 320, the storage device 330 may abut against an abutting surface 32201 on a front side of the armrest 3220 to prevent the storage device 330 from continuing to slide backward (i.e., the direction toward the backrest 310).

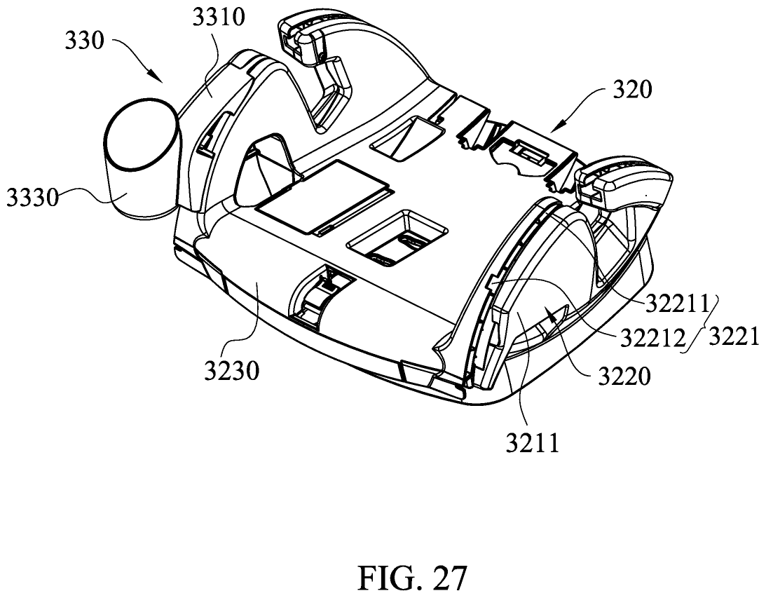

Referring to FIGS. 26 and 27, FIG. 26 schematically shows a perspective view of a storage device 330 according to an embodiment of the present disclosure; and FIG. 27 schematically shows a perspective view of the seat part 320 according to an embodiment of the present disclosure, wherein the armrest 3220 on one side of the seat part 320 is provided with the storage device 330, while the armrest 3220 the other side of the seat part 320 is not provided with the storage device 330 to illustrate an internal structure at a connection between the seat part 320 and the storage device 330. It should be noted that an embodiment in which the storage device 330 is disposed on the seat part 320 is shown, but the present disclosure is not limited thereto, that is, the storage device 330 may also be disposed at other positions of the seat.

As shown in FIGS. 26 and 27, the storage device 330 includes a connecting part 3310 and an accommodating structure 3330. The storage device 330 may be slidably connected to the seat 31 through the connecting part 3310. For example, the storage device 330 may be slidably connected to the seat part 320 and slide with respect to the armrest 3220 of the seat part 320, so that the storage device 330 can be easily installed and detached. The accommodating structure 3330 is fixed on the connecting part 3310 for accommodating objects. In one embodiment, the accommodating structure 3330 may be disposed at one end of the connecting part 3310 in an offset manner. For example, referring to FIG. 27, when the storage device 330 is installed on the armrest 3220 of the seat part 320, the accommodating structure 3330 may be located outside a front end of the connecting part 3310 (outside with respect to the seat part 320).

Further, as shown in FIG. 26, the connecting part 3310 includes a first sliding part 3311. Correspondingly, as shown in FIG. 27, the seat 31 (only the seat part 320 of the seat 31 is shown, for other parts of the seat 31, please referring to FIG. 24) is also provided with a connecting structure 3221. In one embodiment, the first sliding part 3311 extends from one end of the connecting part 3310 and is located on a lower side of the connecting part 3310 for slidingly cooperating with the connecting structure 3221. For example, the connecting structure 3221 may be provided on the seat part 320 (such as its armrest 3220), or may be provided on any side surface of the backrest (not shown). The connecting part 3310 of the storage device 330 may slide forward and backward along the connecting structure 3221 of the seat 31 and be positioned at least one position on the connecting structure 3221.

More specifically, the connecting structure 3221 includes a second sliding part 32211 and a positioning hole 32212 (the positioning hole 32212 will be further described below in combination with FIGS. 31 and 32). The first sliding part 3311 is slidably cooperated with the corresponding second sliding part 32211 provided on the connecting structure 3221. In one embodiment, the second sliding part 32211 is provided on a top surface of the armrest 3220 on at least one side of the seat part 320. More specifically, as shown in FIG. 27, the second sliding part 32211 may be formed between the upright portion on any side of the seat part body 3230 and the corresponding side cover 3211. In one embodiment, the first sliding part 3311 may be a sliding rib with an inverted T-shaped structure (see FIG. 26), and the second sliding part 32211 may be a sliding groove complementary with a shape of the sliding rib (see FIG. 27), but the present disclosure is not limited thereto, and the first sliding part and the second sliding part may also have other shapes that slide and fit with each other.

In addition, in one embodiment, a structure that slidingly cooperated with the second sliding part 32211 may also be provided below the backrest of the seat (see FIG. 24), so as to be slidable along the second sliding part 32211, thereby realizing angle adjustment and folding of the backrest with respect to the seat part.

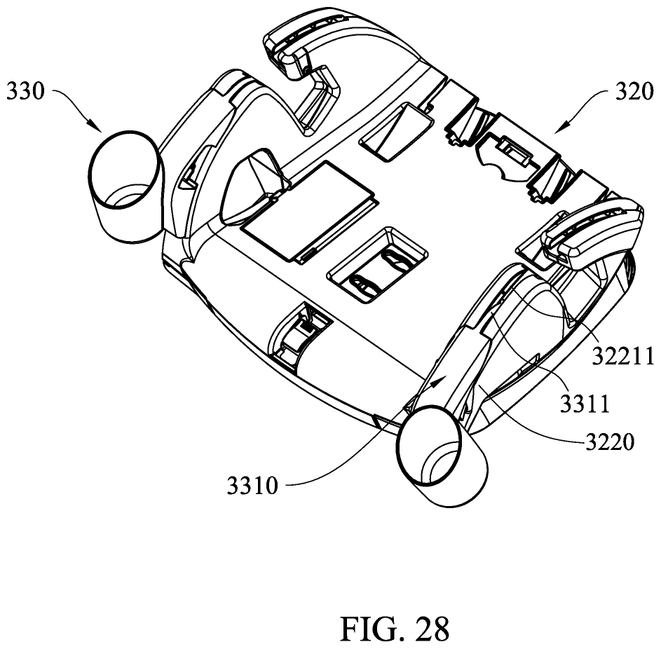

Referring to FIGS. 28 and 29, a process of installing the storage device 330 to the seat part 320 is shown. Specifically, FIG. 28 schematically shows a perspective view of the seat part 320 according to an embodiment of the present disclosure, in which the storage device provided on one side of the seat part 320 is in an installed state, and the storage device provided on the other side of the seat part 320 is being installed; and FIG. 29 schematically shows a perspective view of the seat part 320 according to an embodiment of the present disclosure, in which the storage devices 330 on both sides of the seat part 320 are in the installed state.

As shown in FIGS. 28 and 29, the connecting part 3310 of the storage device 330 may be installed to either side of the seat part 320 from the front end of the seat part 320 along the second sliding part 32211 provided on the armrest 3220.

Through the cooperation of the first sliding part 3311 of the connecting part 3310 and the second sliding part 32211 on the armrest 3220, the storage device 330 may be installed on the seat part 320 from the front of the seat part 320, thereby simultaneously restricting the movement of the storage device 330 in a left-right direction and in an up-down direction of the seat part 320, thereby ensuring the stability of the storage device 330 and the objects placed therein to avoid possible tilting or overturning of the storage device 330 when a child moves to the seat part 320 from one side of the seat and accidentally hits the storage device 330 sideways, or when a child sitting on the seat part 320 accidentally kicks the storage device 330 from below or sideways, thereby preventing the objects in the storage device 330 from spilling.

In addition, FIG. 30 shows a top view of the seat part 320 of FIG. 29 and the storage device 330 provided thereon. As shown in FIG. 30, when the storage device 330 is installed on the armrest 3220 of the seat part 320, the accommodating structure 3330 of the storage device 330 may be offset outward with respect to the seat part 320 at the front end of the entire seat part 320, further reducing the possibility that legs or feet of the child sitting on the seat part 320 accidentally hits the accommodating structure 3330.

Referring to FIGS. 31 and 32, FIG. 31 shows a cross-sectional view of the seat part 320 taken along a line J-J of FIG. 30, and FIG. 32 shows an enlarged view of a part Q shown in FIG. 31.

As shown in FIGS. 31 and 32, the storage device 330 further includes a positioning element 3320, and the positioning element 3320 is provided on the connecting part 3310. The storage device 330 may be positioned at different positions on the connecting structure (only the positioning holes 32212 of the connecting structure are shown in FIG. 32, and the connecting structure will be described in detail later) through the positioning element 3320. In one embodiment, the positioning element 3320 is pivotably connected to the connecting part 3310 of the storage device 330, and has an engaged position (as shown in FIG. 31) in which it is engaged with the connecting structure 3221 and a disengaged position (not shown) in which it is disengaged from the connecting structure 3221. Specifically, when the storage device 330 is installed on the seat part 320, the positioning element 3320 may be disposed between the connecting part 3310 of the storage device 330 and the seat part 320 to prevent sliding between the storage device 330 and the seat part 320 and position the connecting part 3310 on the seat portion 320. For example, one end of the positioning element 3320 may be pivotably connected to the connecting part 3310 through a pin 2324, for example, its connecting position is at a pivot point P3 as shown in FIG. 32. In combination with FIGS. 31 and 32, it can be seen that one end of the positioning element 3320 that is pivotally connected to the connecting part 3310 (i.e., an end close to the pivot point P3) is further away from the accommodating structure 3330 of the storage device 330 than the other end of the positioning element 3320.

In one embodiment, the positioning element 3320 further includes an elastic arm 3321. The elastic arm 3321 has an arm-like structure extending from one end of the positioning element 3320 toward the other end of the positioning element 3320. Specifically, as shown in FIGS. 31 and 32, the arm-like structure of the elastic arm 3321 extends from a first end 3320a of the positioning element 3320 (that is, an end close to the pivot point P3) toward a second end 3320b of the positioning element 3320 (that is, an end away from the pivot point P3), and the arm-like structure is spaced apart from the second end 3320b with a certain distance. In addition, an end 2321a of the elastic arm 3321 abuts against an inner surface of the connecting part 3310 to bias a main part of the positioning element 3320 toward the seat part 320 therebelow, and then position the connecting part 3310 when the connecting part 3310 slides to an appropriate position of the seat (for example, the seat part 320 as shown in FIG. 31).

In one embodiment, the positioning element 3320 further includes a positioning protrusion 3322. The positioning protrusion 3322 is located on a lower side of the other end of the positioning element 3320 for engaging with the seat, so that the connecting part 3310 is positioned on the seat. More specifically, as shown in FIGS. 31 and 32, the connecting part 3310 may be positioned on the seat part 320, such as its armrest 3220, through the positioning protrusion 3322. Correspondingly, at least one positioning hole 32212 is provided on the second sliding part 32211 of the seat (in combination with FIG. 27) for engaging with the positioning protrusion 3322. For the arrangement of the positioning holes 32212, a perspective view of the armrest 3220 and the second sliding part 32211 thereon is shown in FIG. 27, which shows a positional relationship between the second sliding part 32211 and the positioning hole 32212. For example, the positioning hole 32212 may be provided as an opening extending from one side of the second sliding part 32211. In addition, the positioning hole 32212 may be provided as one positioning hole or a plurality of positioning holes, so that the storage device 330 may be positioned at several positions on the armrest 3220 of the seat part 320 through the selective engagement between the positioning protrusion 3322 of the positioning element 3320 and the positioning hole 32212. When the seat is used by a smaller child, the storage device 330 may be adjusted to a backward position (i.e., closer to the backrest), so that the smaller child can easily access the objects in the storage device 330. When the seat is used by a larger child, the storage device 330 may be adjusted to a forward position (i.e., away from the backrest), so that it is convenient for the older child to access the objects in the storage device 330, and will not limit the movement space of the child's arms.

By providing the positioning element 3320 with the elastic arm 3321 and the positioning protrusion 3322 on the connecting part 3310, as the elastic arm 3321 of the positioning element 3320 constantly provides a force to bias the positioning protrusion 3322 toward the seat, the positioning protrusion 3322 is engaged with the corresponding positioning hole 32212 on the connecting structure 3221 under the bias of the elastic arm 3321 when the storage device 330 slides to the appropriate position with respect to the seat, so that the storage device 330 is positioned at this position. Thus, the storage device 330 can be positioned in different usage positions as desired, further improving convenience of use and user experience.

Referring to FIGS. 33 and 34, FIG. 33 shows a perspective view of the seat part 320 of FIG. 29 from another angle, and FIG. 34 shows an enlarged view of a part J shown in FIG. 33. FIG. 33 shows the positioning element 3320 provided in the connecting part 3310 viewed from the other side, and when viewed from this side, at least a part of the positioning element 3320 is visible (i.e., not shielded).

As shown in FIG. 33 and FIG. 34, in one embodiment, the positioning element 3320 further includes an operating part 3323. In one embodiment, the operating part 3323 is located on an upper side of the other end of the positioning element 3320 (e.g., the second end 3320b), and is at least partially exposed. For example, an opening may be provided on a side of the armrest 3220 close to a sitting position of the child, so that the operating part 3323 is visible from the outside, and the user can contact or grasp the operating part 3323 for manual operation. By operating the operating part 3323, the positioning element 3320 may be disengaged from the seat, so that the storage device 330 may slide to other positions with respect to the seat. For example, in one embodiment, the operating part 3323 may be pulled upward to overcome an elastic rotation of the elastic arm 3321 (that is, to overcome a biasing force provided by the elastic rotation to the positioning protrusion 3322), so that the positioning protrusion 3322 is disengaged with the positioning hole 32212 provided on the seat part 320. At this time, the storage device 330 may be continued to be pulled in an axial direction, so that the connecting part 3310 of the storage device 330 (such as the first sliding part as described above) slides on the armrest 3220 of the seat part 320 (such as the second sliding part as described above) to detach the storage device 330 from the seat part 320, or adjust the storage device 330 to another position and engage with another positioning hole, thereby being suitable for children of different sizes, and further improving the operational convenience.

Through the sliding connection between the connecting part and the seat, the storage device of the present disclosure can slide forward and rearward and detachably installed on the seat, thereby restricting the movement of the storage device in the left-right direction and the vertical direction of the seat. When the child on the seat accidentally kicks the storage device from below, or when the child accidentally hits the storage device sideways while moving from one side of the seat to the seat part, the storage device according to the present disclosure can ensure the stability of the storage device and the objects placed therein, and improve the usage safety and user experience of the seat. In addition, the storage device and the seat according to the present disclosure are simple in structure and easy to be assembled and disassembled, and the storage device may be detached from the seat when it is not needed, thereby reducing the packaging volume of the seat and reducing the transportation cost.

Although relative terms such as “above” and “under” are used herein to describe the relationship of one component with respect to another component, such terms are used herein only for the sake of convenience, for example, in the direction shown in the figure, it should be understood that if the referenced device is inversed upside down, a component described as “above” will become a component described as “under”. When a structure is described as “above” another structure, it probably means that the structure is integrally formed on another structure, or, the structure is “directly” disposed on another structure, or, the structure is “indirectly” disposed on another structure through an additional structure.

The terms “a”, “an”, “the”, “said” and “at least one”, are used to express the presence of one or more the element/constitute/or the like. The terms “comprise”, “include” and “have” are intended to be inclusive, and mean there may be additional elements/constituents/or the like other than the listed elements/constituents/or the like. The “first” and “second” are used only as marks, and are not numerical restriction to the objects.

Unless otherwise defined, all terms including technical and scientific terms used herein have the same meaning as commonly understood by those ordinary skill in the art to which the present disclosure belongs. It should also be understood that a term should be interpreted as having a meaning consistent with its meaning in the context of the related art, and will not be interpreted as an idealized or overly formal meaning unless explicitly defined herein.

It should be understood that the application of the present disclosure is not limit to the detailed structure and arrangement of components provided in this specification. The present disclosure can have other embodiments, and can be implemented and carried out in various ways. The aforementioned variations and modifications fall within the scope of the present disclosure.

1. A seating assembly for detachably connecting to a backrest of a child safety seat, wherein, the seating assembly comprises:
a base;
a seating body slidably connected to the base, the seating body being positioned at different positions with respect to the base; and
a movable element located between the backrest and the seating body, wherein when the backrest is detached with respect to the seating body, the movable element is disengaged from the backrest and locked with the base to lock movement of the seating body with respect to the base.

2. The seating assembly according to claim 1, wherein, an engaging hole is formed in the base, and when the backrest is detached with respect to the seating body, the movable element is disengaged from the backrest and is engaged with the engaging hole.

3. The seating assembly according to claim 1, wherein, an engaging hole is formed in the base, the movable element comprises a rotating rod rotatably connected to the seating body and an elastic element connected to the rotating rod, the rotating rod comprises a first end and a second end,
when the backrest is not detached, the second end of the rotating rod is pressed by the backrest, so that the first end is opposite to the engaging hole and located outside the engaging hole, and the elastic element is configured to provide a force for moving the first end of the rotating rod toward the engaging hole.

4. The seating assembly according to claim 3, wherein, the backrest comprises an abutting element, and when the backrest is not detached, the abutting element abuts against the second end of the rotating rod.

5. The seating assembly according to claim 1, wherein, when the seating body slides to a preset position with respect to the base, the backrest is in a vertical state.

6. The seating assembly according to claim 1, wherein, the seating assembly comprises an adjustment assembly between the base and the seating body, the base comprises a positioning guide rail, and the positioning guide rail is provided with a plurality of positioning holes spaced apart from each other, and the seating body is slidably provided on the base and cooperates with respective one of the positioning holes through the adjustment assembly.

7. The seating assembly according to claim 6, wherein, the seating body is provided with a guide slot for accommodating the positioning guide rail, a length of the guide slot is greater than a length of the positioning guide rail, the seating body comprises a first abutting part, and the first abutting part is placed on a side of the guide slot away from the backrest to abut against the positioning guide rail when the seating body slides to a preset position.

8. The seating assembly according to claim 6, wherein,
the seating body comprises a seat body, and the seat body comprises an upper shell and a lower shell connected to each other,
the adjustment assembly comprises a positioning element connected between the upper shell and the lower shell, an elastic element connected to the positioning element, and an adjusting element connected to the positioning element,
the positioning element is selectively placed in one of the positioning holes, and the adjusting element is movably connected to the lower shell.

9. The seating assembly according to claim 8, wherein,
the positioning element comprises a positioning rod, a connecting element connected to the positioning rod, and a linking element connected between the adjusting element and the connecting element,
the lower shell is formed with a first guide groove, an extending direction of the first guide groove is parallel to an axial direction of the positioning hole, the connecting element is movably placed in the first guide groove, the connecting element is formed with a receiving groove, and the elastic element is placed in the receiving groove and abuts against the connecting element.

10. The seating assembly according to claim 9, wherein, the seating body further comprises armrests on both sides of the seat body, and a connecting hole corresponding to the first guide groove is formed on an inner side of the armrest, and the positioning element passes through the positioning hole and is placed in the connecting hole.

11. The seating assembly according to claim 1, wherein, the backrest comprises a locking element,
when the seating body does not slide to a preset position with respect to the base, the locking element is not capable of being unlocked, and
when the seating body slides to the preset position with respect to the base, the locking element is capable of being unlocked.

12. The seating assembly according to claim 11, wherein, a rear edge of the base is formed with an avoidance slot facing the backrest, and when the seating body slides to a preset position, the locking element is opposite to the avoidance slot, so as to allow the backrest to be detached,
wherein, the locking element comprises an engaging hook and an operating element rotatably provided on the backrest, the seating assembly further comprises an engaging rod fixed on the seating body, the engaging hook is fixedly connected to the operating element, the engaging hook has a hook part facing the engaging rod and hooking the engaging rod, the engaging hook slides with respect to the base along with the seating body, and the hook part is opposite to the avoidance slot when the seating body slides to the preset position.

13. The seating assembly according to claim 11, wherein, a rear edge of the base is formed with an avoidance slot facing the backrest,
when the seating body slides to a preset position, the locking element is unlocked through the avoidance slot, and
when the seating body does not slide to the preset position, the locking element is not capable of being unlocked through the avoidance slot.

14. The seating assembly according to claim 13 wherein, the locking element comprises an engaging hook and an operating element rotatably provided on the backrest, the seating assembly further comprises an engaging rod fixed on the seating body, the engaging hook is fixedly connected to the operating element, the engaging hook has a hook part facing the engaging rod and hooking the engaging rod, the engaging hook slides with respect to the base along with the seating body, and the hook part is opposite to the avoidance slot when the seating body slides to the preset position.

15. The seating assembly according to claim 6, wherein, the seating body comprises a seat body, the seat body is formed with an accommodating groove for receiving the locking element, and the locking element is fixed to a bottom end of the backrest.

16. The seating assembly according to claim 1, wherein, the seating body includes an armrest, a top portion of the armrest is formed with a first curved sliding slot and a second curved sliding slot communicated with each other, the backrest comprises a leaning part and side leaning parts on both sides of the leaning part, a sliding part protrudes from a bottom portion of each of the side leaning parts, the sliding part is slidably placed in the first curved sliding slot, a cross-section of each of the first curved sliding slot and the second curved sliding slot is matched with a cross-section of the sliding part.

17. The child safety seat according to claim 49, wherein
the folding mechanism is configured to fold a backrest of a child safety seat with respect to a seat part, and wherein, the folding mechanism comprises:
a sliding groove disposed on one of the seat part and the backrest;
a sliding rib disposed on the other of the seat part and the backrest;
a locking structure operated to switch between a locking position and an unlocking position, wherein the backrest is fixed with respect to the seat part and is in an unfolded state when the locking structure is in the locking position; and the backrest is foldable with respect to the seat part by means of sliding fit between the sliding groove and the sliding rib to be in a folded state when the locking structure is in the unlocking position.

18. The child safety seat according to claim 17, wherein, the sliding groove is disposed on each of both sides of the seat part, and the sliding rib is disposed on each of both sides of the backrest, wherein
the sliding groove is disposed on a top surface of an armrest at each of both sides of the seat part,
the armrest at each of both sides of the seat part comprises a front armrest and a rear armrest spaced apart from each other;
in an unfolded state, the sliding rib is in a rear sliding groove of the rear armrest, and
in a folded state, the sliding rib is in a front sliding groove of the front armrest.

19-22. (canceled)

23. The child safety seat according to claim 17, wherein, the locking structure is disposed at a lower side of the backrest;
the folding mechanism further comprises an engaging rod fixed to the child safety seat, and the locking structure is in the locking position by the engagement with the engaging rod and is in the unlocking position by the disengagement from the engaging rod.

24-48. (canceled)

49. A child safety seat, wherein, the child safety seat comprises:
the seating assembly according to claim 1; and
a folding mechanism, allowing a backrest of the child safety seat to be folded or selectively separated with respect to the seating body.
